(19) United States
(12) Patent Application Publication
(10) Pub. No.: US 2007/0124470 A1
(43) Pub. Date: May 31, 2007

(54) Computer for displaying parent object automatically and display method therefore

(76) Inventors: Kazuo Ookubo, Yokohama (JP); Hiroshi Sugitani, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/338,710

(22) Filed: Jan. 25, 2006

(30) Foreign Application Priority Data
Nov. 8, 2005 (JP) 2005-323585

(51) Int. Cl. G06F 15/173

(52) U.S. Cl. 709/225

(57) ABSTRACT

Provided is a method of managing a computer system including a host computer and a storage subsystem, the host computer and the storage ubsystem being coupled to a management computer through a first network, the host computer and the storage subsystem being coupled to each other through a second network, the management computer including an input device for receiving an input, and an output device for displaying information, the method including: displaying objects included in the computer system and related to one another in a display area of the output device; and displaying, when the input device receives an input of designating one of the objects, an object related to be higher than the designated object in a form different from a form of the other objects in the display area of the output device. Accordingly, it is possible to specify parent objects related to a lower object with ease.

### CROSS-REFERENCE TO PRIOR APPLICATION

This application relates to and claims priority from Japanese Patent Application No. 2005-323585, filed on Nov. 8, 2005 the entire disclosure of which is incorporated herein by reference.

### BACKGROUND

This invention relates to a technology for a computer system which includes a plurality of tiered objects, and more particularly to a method of displaying tiered objects.

For example, JP 2004-341994 A discloses a graphical user interface (GUI) for displaying on a screen a plurality of tiered objects (components) included in a computer system. According to JP 2004-341994 A, the GUI displays a host computer and a logical unit (LU) managed by the host computer in a tree-shaped graphic. Accordingly, JP 2004-341994 A allows a tier structure of objects to be displayed for visual clarity. A system administrator can easily specify a lower object (child object) related to an upper object (parent object) in the tier structure by using the GUI.

### SUMMARY

In a computer system, a single child object may be related to a plurality of parent objects. For example, when the host computer accesses each logical device in a storage system, the logical device is related to the storage system which stores it, and simultaneously to the host computer which accesses the logical device. In this case, the host computer and the storage system are both parent objects of the logical device.

For example, in order to learn which storage system a logical device accessed by a certain host computer belongs to, the system administrator must refer to child objects of all storage systems to check whether the target logical device is included in the child objects or not. As the number of objects to be checked is larger, or as tiers of the objects are lower, work for the checking increases in amount.

Thus, according to the conventional technology, while it is easy to specify the child object related to the parent object, it is not easy to specify all the parent objects related to the child object when a single child object is related to the plurality of parent objects.

According to an exemplary embodiment of this invention, there is disclosed a method of managing a computer system including a host computer and a storage subsystem, the host computer and the storage subsystem being coupled to a management computer through a first network, the host computer and the storage subsystem being coupled to each other through a second network, the management computer including a first interface for communicating through the first network, a first processor coupled to the first interface, a first memory coupled to the first processor, an input device for receiving an input, and an output device for displaying information, the host computer including a second interface coupled to the first network, a third interface coupled to the second network, a second processor coupled to the second interface and the third interface, and a second memory coupled to the second processor, the storage subsystem including a disk drive for storing data used by the host computer, and a controller for controlling the disk drive, the method including: displaying objects included in the computer system and related to one another in a display area of the output device; and displaying, when the input device receives an input of designating one of the objects, an object related to be higher than the designated object in a form different from a form of the other objects in the display area of the output device.

According to an embodiment of this invention, it is possible to specify parent objects related to a child object with ease.

### BRIEF DESCRIPTION OF THE DRAWINGS

FIG. 1 is a block diagram showing a configuration of a computer system according to an embodiment of this invention.

FIG. 2 is a block diagram showing a configuration of an administrator PC according to the embodiment of this invention.

FIG. 3 is a block diagram showing a configuration of a management server according to the embodiment of this invention.

FIG. 4 is a block diagram showing a configuration of a host according to the embodiment of this invention.

FIG. 5 is a block diagram showing a configuration of a controller according to the embodiment of this invention.

FIG. 6 is a block diagram showing a logical configuration of the computer system according to the embodiment of this invention.

FIGS. 7A and 7B are explanatory diagrams of information which is obtained from the host by a collection program according to the embodiment of this invention.

FIGS. 8A and 8B are explanatory diagrams of information which is obtained from a subsystem by the collection program.

FIGS. 9A and 9B are explanatory diagrams of LDEV assignment information according to the embodiment of this invention.

FIG. 10 is an explanatory diagram of LU assignment information according to the embodiment of this invention.

FIG. 11 is an explanatory diagram of an object management table regarding the subsystem according to the embodiment of this invention.

FIG. 12 is an explanatory diagram of an object management table regarding the host according to the embodiment of this invention.

FIG. 13 is an explanatory diagram of a display control table according to the embodiment of this invention.

FIG. 14 is an explanatory diagram of a display memory according to the embodiment of this invention.

FIG. 15 is an explanatory diagram of a screen displayed on an output device according to the embodiment of this invention.

FIG. 16 is a flowchart of an object display process executed by an object display program according to the embodiment of this invention.

FIG. 17 is a flowchart of a relation highlighting process executed by the object display program according to the embodiment of this invention.

FIG. 18 is a flowchart of a display changing process executed by the object display program according to the embodiment of this invention.

FIG. 19 is a flowchart of another display changing process executed by the object display program according to the embodiment of this invention.

FIG. 20 is an explanatory diagram of a method of describing objects in the description of the display position information updating process according to the embodiment of this invention.

FIG. 21 is a flowchart of the display position information updating process executed by the object display program according to the embodiment of this invention.

FIG. 22 is a flowchart of a position information setting process executed by the object display program according to the embodiment of this invention.

FIG. 23 is an explanatory diagram of the display memory when the screen displayed in the output device is divided according to the embodiment of this invention.

FIG. 24 is an explanatory diagram of an example of a screen displayed in the output device according to the embodiment of this invention.

FIG. 25 is an explanatory diagram of an example of a screen displayed with selection highlighting in the output device according to the embodiment of this invention.

FIG. 26 is an explanatory diagram of an example of a screen displayed with relation highlighting in the output device according to the embodiment of this invention.

FIG. 27 is an explanatory diagram of an example of a screen which includes a third display area displayed in the output device according to the embodiment of this invention.

FIG. 28 is an explanatory diagram of an example of a screen divided and displayed in the output device according to the embodiment of this invention.

FIG. 29 is an explanatory diagram of an example of a screen where a boundary line displayed in the output device is moved according to the embodiment of this invention.

### DETAILED DESCRIPTION OF THE PREFERRED EMBODIMENTS

Embodiments of this invention will be described below with reference to the drawings.

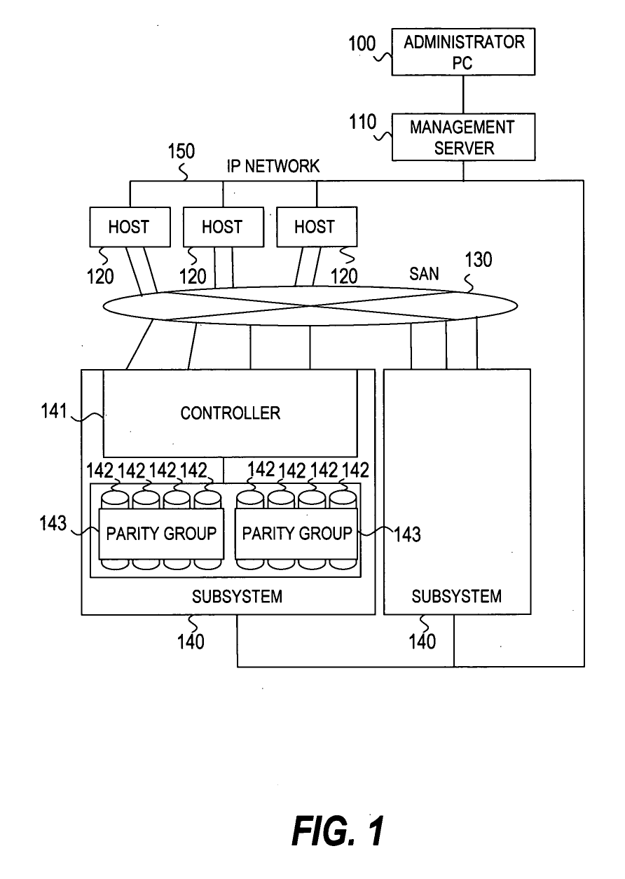

FIG. 1 is a block diagram showing a configuration of a computer system according to an embodiment of this invention.

The computer system of the embodiment includes an administrator PC 100, a management server 110, one or more hosts 120, and one or more subsystems 140.

Each host 120 and each subsystem 140 are connected to each other through a so-called storage area network (SAN) 130. The management server 110 is connected to each host 120 and each subsystem 140 through an Internet Protocol (IP) network 150. Other types of networks can be used in place of the SAN 130 and the IP network 150.

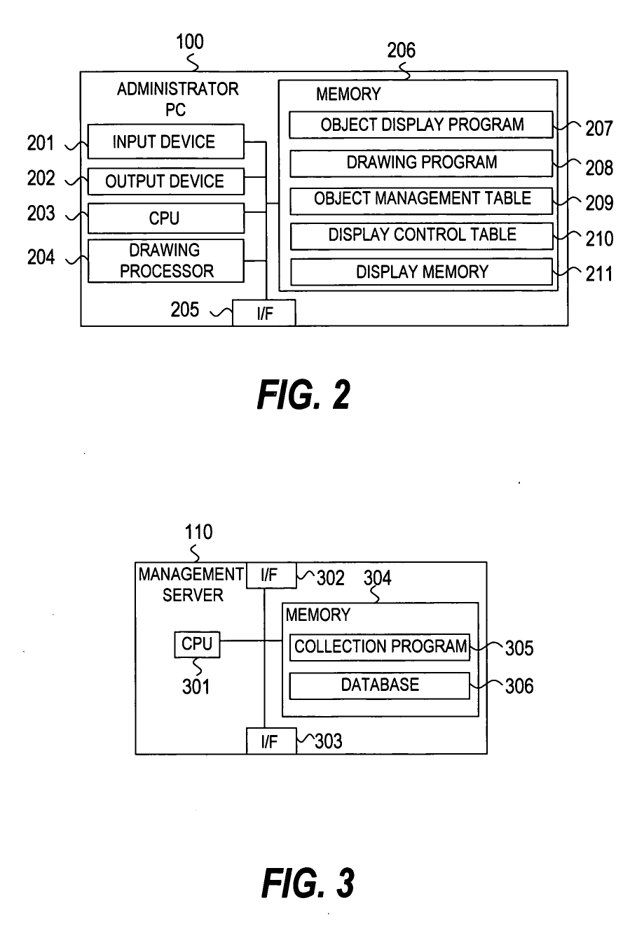

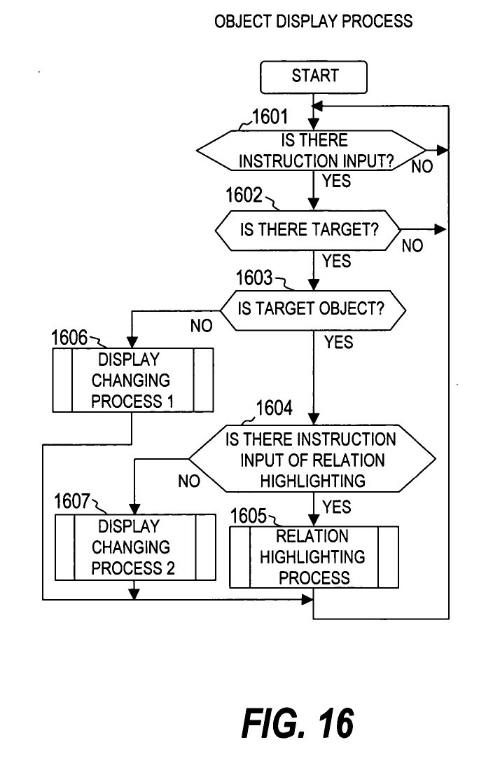

The administrator PC 100 is a computer used by a system administrator to manage the computer system of the embodiment. The administrator PC 100 may be a so-called personal computer (PC) connected to the management server 110. As described below in detail, the administrator PC 100 executes a parent object displaying method of this invention shown in FIG. 16 or the like. A configuration of the administrator PC 100 shown in FIG. 2 will be described below in detail.

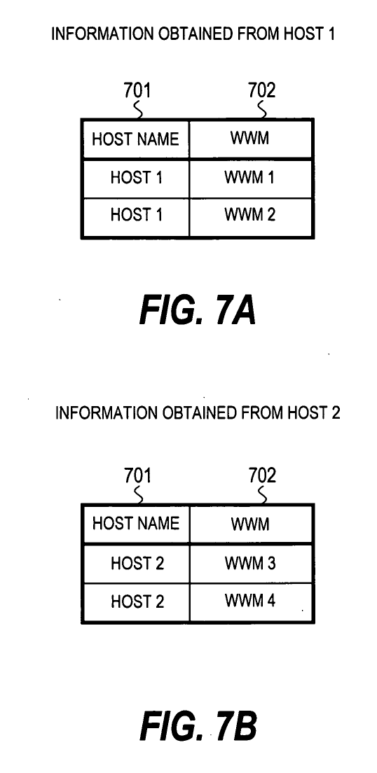

The management server 110 is a computer for managing the computer system of the embodiment. The management server 110 communicates with the host 120 and the subsystem 140 through the IP network 150 to obtain various pieces of information shown in FIG. 7 or the like. A configuration of the management server 110 shown in FIG. 3 will be described below in detail.

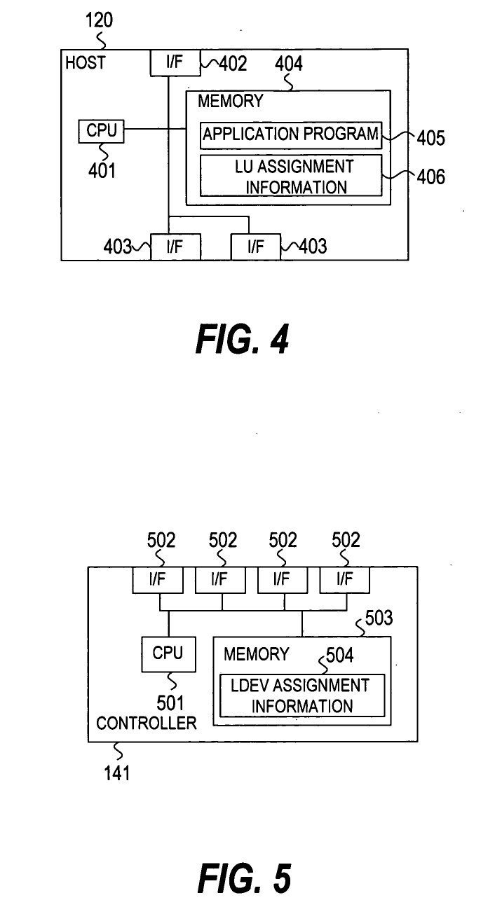

The host 120 is a computer which uses the subsystem 140. A user executes various applications by using the host 120. The host 120 writes data in the subsystem 140 or reads data therefrom if necessary. A configuration of the host 120 shown in FIG. 4 will be described below in detail.

The subsystem 140 is a storage system (storage subsystem) for storing the data written by the host 120. The subsystem 140 includes a controller 141 and a plurality of disk drives 142.

The controller 141 receives a data writing or reading request from the host 120 through the SAN 130, and receives/transmits target data of the request. Additionally, the controller 141 controls the disk drive 142 to write or read the target data of the request therein/therefrom. A configuration of the controller 141 shown in FIG. 5 will be described below in detail.

For example, each disk drive 142 is a hard disk drive (HDD). The disk drive 142 stores the data written from the host 120.

The plurality of disk drives 142 constitute a so-called redundant arrays of inexpensive disks (RAID). A predetermined number (e.g., 4) of disk drives 142 constitutes one parity group 143. The parity group 143 is a unit to constitute the RAID. When data of one disk drive 142 of one parity group is lost due to a fault or the like, the lost data is restored based on data of the remaining disk drives 142 of the parity group 143. The subsystem 140 can include an optional number of parity groups 143.

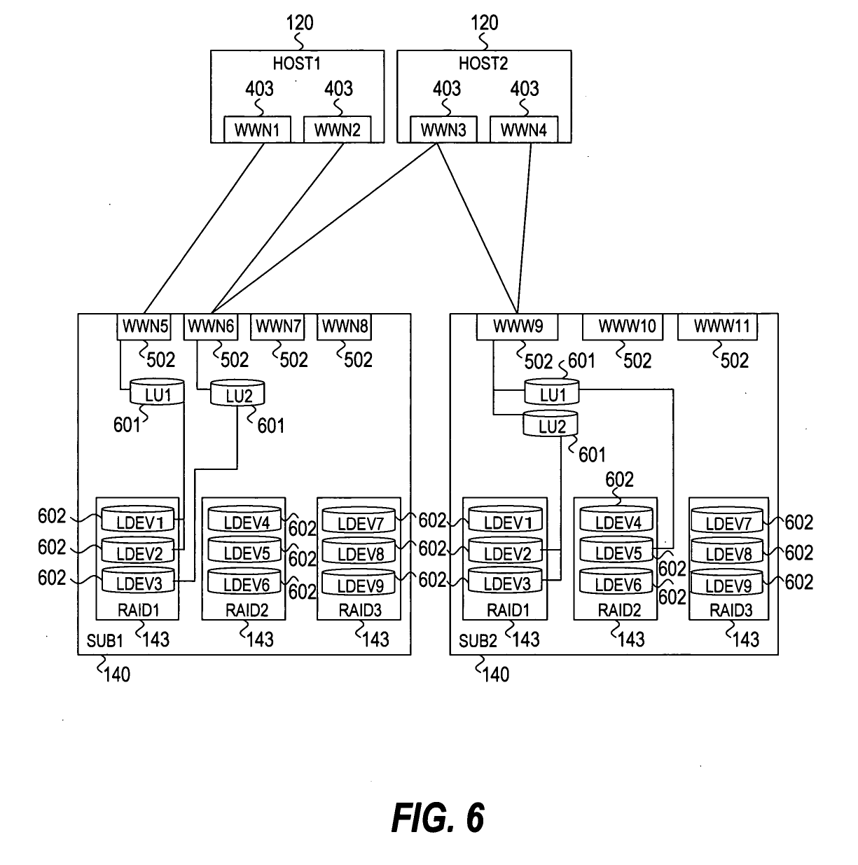

Now, objects will be described. The objects are physical or logical components to be targeted for various processing operations in the computer system. For example, in FIG. 1, each host 120, each subsystem 140, and each parity group 143 are objects. Further, each logical device (LDEV) and each logical unit (LU) described below are objects (see FIG. 6).

Each object may be related to other objects.

For example, when a parity group 143 of a certain subsystem 140 includes a given logical device, the parity group 143 is related to be lower than the subsystem 140, and the logical device is related to be lower than the parity group 143. An object directly related above a certain object will be referred to as a parent object, and an object directly related below the certain object will be referred to as a child object.

In the description below, objects related above (or related upper objects) include objects related to be higher than the parent object in addition to the parent object.

Next, each unit of the computer system of the embodiment will be described.

FIG. 2 is a block diagram showing the configuration of the administrator PC 100 according to the embodiment of this invention.

The administrator PC 100 of the embodiment includes an input device 201, an output device 202, a CPU 203, a drawing processor 204, an interface (I/F) 205, and a memory 206 which are connected to one another.

The input device 201 is used by the system administrator to input an instruction or data to the administrator PC 100. According to the embodiment, to provide a graphical user interface (GUI), the input device 201 includes at least a pointing device (e.g., mouse) for designating objects displayed in the output device 202.

The output device 202 is used by the administrator PC 100 to display information to the system administrator. According to the embodiment, to visually display objects of the computer system by the GUI, the output device 202 includes at least a display screen (e.g., CRT or liquid crystal screen).

The CPU 203 is a processor for executing a program stored in the memory 206.

The drawing processor 204 executes processing for displaying a screen in the output device 202. Specifically, the drawing processor 204 executes a drawing program 208 stored in the memory 206 to display the screen in the output device 202 according to information stored in a display memory 211. It should be noted that the drawing processor 204 is disposed to execute the processing for displaying the screen at a high speed. Accordingly, when high-speed processing is not required, the administrator PC 100 does not need to include the drawing processor 204. In this case, the CPU 203 executes the drawing program 208.

The I/F 205 is connected to the IP network through the management server 110, and used by the administrator PC 100 to communicate with the management server 110. The communication with the management server 110 through the I/F 205 enables the administrator PC 100 to refer to pieces of information collected from the host computer 120 and the subsystem 140 by the management server 110.

The memory 206 stores the program executed by the CPU 203 or the drawing processor 204. The memory 206 further stores information referred to when the program is executed. For example, the memory 206 may be a semiconductor memory, a hard disk drive, or a combination thereof.

The memory 206 of the embodiment stores an object display program 207, a drawing program 208, an object management table 209, a display control table 210, and the display memory 211. Those programs and the like will be described below in detail.

FIG. 3 is a block diagram showing the configuration of the management server 110 according to the embodiment of this invention.

The management server 110 of the embodiment includes a CPU 301, an I/F 302, an I/F 303, and a memory 304 which are connected to one another.

The CPU 301 is a processor for executing a program stored in the memory 304.

The I/F 302 is connected to the administrator PC 100, and used by the system management sever 110 to communicate with the administrator PC 100.

The I/F 303 is connected to each host 120 and each subsystem 140 through the IP network 150, and used for communicating with the host 120 and the like. For example, the I/F 303 may be an ordinary network interface card (NIC).

The memory 304 stores the program and the like executed by the CPU 301. For example, the memory 304 may be a semiconductor memory, a hard disk drive, or a combination thereof.

The memory 304 of the embodiment stores a collection program 305 and a database 306. The collection program 305 collects pieces of information regarding objects from each host 120 and each subsystem 140 to store them in the database 306. The pieces of information collected by the collection program 305 shown in FIGS. 7A and 7B, or the like will be described below in detail.

According to the embodiment, the administrator PC 100 and the management server 110 are realized by different hardware. However, one hardware may serve as both of the administrator PC 100 and the management server 110. For example, the I/F 205 of the administrator PC 100 having the collection program 305 and the database 306 stored in the memory 206 may be directly connected to the IP network 150.

FIG. 4 is a block diagram showing the configuration of the host 120 according to the embodiment of this invention.

The host 120 of the embodiment includes a CPU 401, an I/F 402, an I/F 403, and a memory 404 which are connected to one another.

The CPU 401 is a processor for executing a program stored in the memory 404.

The I/F 402 is connected to each management server 110 through the IP network 150, and used for communicating with the management server 110. For example, the I/F 402 may be an ordinary network interface card (NIC).

The I/F 403 is connected to the SAN 130 to communicate with the subsystem 140 therethrough. When a fiber channel (FC) protocol is used in the SAN 130, for example, the I/F 403 is a so-called host bus adapter (HBA). The host 120 may include a plurality of I/F's 403.

The memory 404 stores the program executed by the CPU 401. For example, the memory 404 may be a semiconductor memory, a hard disk drive, or a combination thereof.

The memory 404 of the embodiment stores an application program 405 and LU assignment information 406. The application program 405 is used by the user of the host 120 to execute various applications. The memory 404 may store a plurality of application programs 405. The application program 405 issues an access request to the logical unit (LU) in the subsystem 140 if necessary. The LU assignment information 406 contains information on a relation between each host 120 and each LU. The LU assignment information 406 shown in FIGS. 7A and 7B, or the like will be described below in detail.

FIG. 5 is a block diagram showing the configuration of the controller 141 according to the embodiment of this invention.

The controller 141 of the embodiment includes a CPU 501, an I/F 502, and a memory 503.

The CPU 501 is a processor for executing a program (not shown) stored in the memory 503.

The I/F 502 is connected to the SAN 130 to communicate with the host 120 therethrough. The controller 141 may include a plurality of I/F's 502.

The memory 503 stores the program (not shown) executed by the CPU 501 and the other information. For example, the memory 503 may be a semiconductor memory.

The memory 503 of the embodiment stores LDEV assignment information 504. The LDEV assignment information 504 contains information on a relation between each LDEV and each LU.

The host 120 and the LDEV are related to each other based on the LU assignment information 406 and the LDEV assignment information 504.

FIG. 6 is a block diagram showing a logical configuration of the computer system according to the embodiment of this invention.

FIG. 6 shows a logical configuration of the computer system of the embodiment shown in FIG. 1. FIG. 6 shows only two hosts 120 and two subsystems 140 for explanation. Other portions and a detailed configuration are not shown.

In FIG. 6, each host 120 is identified by a host name. A host name of one host 120 shown in FIG. 6 is “Host 1”, and a host name of another is “Host 2”. In the description below, the host 120 whose name is “Host 1” will be simply referred to as Host 1. The same will apply for the Host 2.

Each subsystem 140 is identified by a subsystem name. A subsystem name of one subsystem 140 shown in FIG. 6 is “SUB 1”, and a subsystem name of another is “SUB 2”. In the description below, the subsystem 140 whose name is “SUB 1” will be simply referred to as “SUB 1. The same will apply for the SUB 2.

The I/F 403 of each host 120 and the I/F 502 of each subsystem 140 are identified by world wide names (WWN). The WWN is an identifier to uniquely identify each I/F 403 or each I/F 502 in the world. In an example of FIG. 6, WWN's of two I/F's 403 disposed in the Host 1 are respectively “WWN 1” and “WWN 2”. WWN's of two I/F's 403 disposed in the Host 2 are respectively “WWN 3” and “WWN 4”. WWN's of four I/F's 502 disposed in the controller 141 of the SUB 1 are respectively “WWN 5”, “WWN 6”, “WWN 7”, and “WWN 8”. WWN's of three I/F's 502 disposed in the controller 141 of the SUB 2 are respectively “WWN 9”, “WWN 10”, and “WWN 11”. In the description below, the I/F 403 whose WWN is “WWN 1” will be simply referred to as WWN 1. The same will apply for the WWN 2 or the like, and the I/F 502.

The parity group 143 of each subsystem 140 is identified by a unique parity group name in the subsystem 140. In the example of FIG. 6, parity group names of three parity groups 143 disposed in the SUB 1 are respectively “RAID 1”, “RAID 2”, and “RAID 3”. Parity group names of three parity groups 143 disposed in the SUB 2 are respectively “RAID 1”, “RAID 2”, and “RAID 3”. In the description below, the parity group 143 whose name is “RAID 1” will be simply referred to as RAID 1. The same will apply for the RAID 2 and the like.

Each parity group 143 includes an optional number of logical devices (LDEV) 602. The LDEV 602 is a logical storage area constituted of physical storage areas of one or more disk drives 142.

In the example of FIG. 6, each parity group 143 includes three LDEV's 602. Each LDEV 602 is identified by a unique LDEV name in the subsystem 140. In the SUB 1 and the SUB 2, LDEV names of three LDEV's 602 included in the RAID 1 are respectively “LDEV 1”, “LDEV 2”, and “LDEV 3”. LDEV names of three LDEV's 602 included in the RAID 2 are respectively “LDEV 4”, “LDEV 5”, and “LDEV 6”. LDEV names of three LDEV's 602 included in the RAID 3 are respectively “LDEV 7”, “LDEV 8”, and “LDEV 9”. In the description below, the LDEV 602 whose name is “LDEV 1” will be simply referred to as LDEV 1. The same will apply for the LDEV 2 and the like.

As described above, when the subsystem 140 includes the parity group 143, and the parity group 143 includes the LDEV 602, these objects are related to each other. For example, in FIG. 6, the SUB 1 is a parent object of its RAID 1, and the RAID 1 of the SUB 1 is a child object of the SUB 1. The RAID 1 is a parent object of the LDEV 1, and the LDEV 1 is a child object of the RAID 1.

The LU 601 set in the subsystem 140 is recognized as one logical storage apparatus by the host 120. Each controller 141 assigns one or more LDEV's 602 to one logical unit (LU) 601. Each LU 601 is identified by an LU name.

In the example of FIG. 6, the SUB 1 includes two LU's 601. LU names of those LU's 601 are respectively “LU 1” and “LU 2”. In the description below, the LU 601 whose name is “LU 1” will be simply referred to as LU 1. The same will apply for the LU 2. LDEV 1 and LDEV 2 of the SUB 1 are assigned to the LU 1 of the SUB 1 of FIG. 6. LDEV 3 of the SUB 1 is assigned to the LU 2 of the SUB 1.

The SUB 2 of FIG. 6 includes LU 1 and LU 2. LDEV 5 of the SUB 2 is assigned to the LU 1 of the SUB 2. LDEV 2 and LDEV 3 of the SUB 2 are assigned to the LU 2 of the SUB 2.

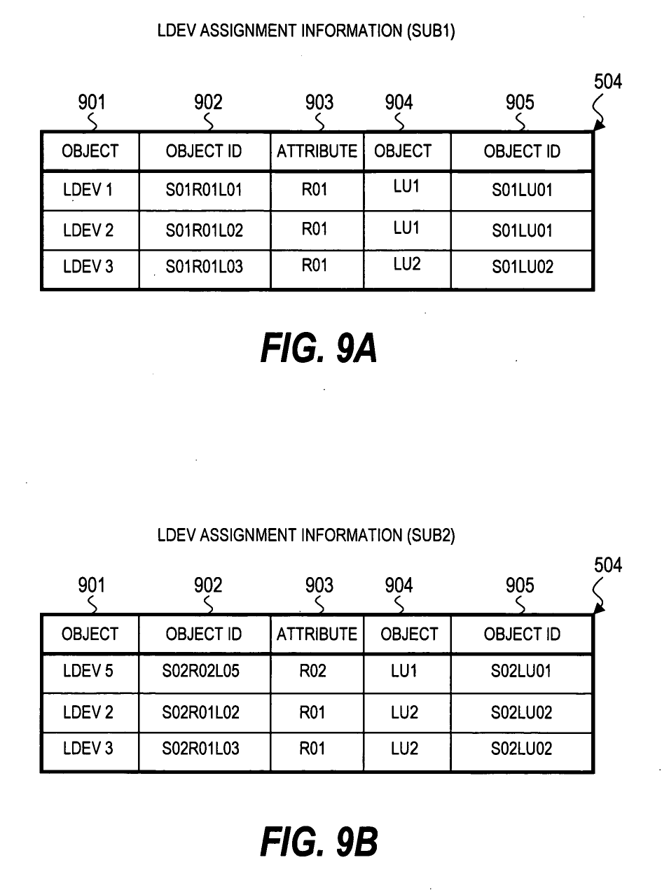

Assignment of the LDEV 602 to the LU 601 is defined based on LDEV assignment information shown in FIGS. 9A and 9B.

An access path is set between the host 120 and the LU 601. The host 120 can access the LU 601 through the set path.

In the example of FIG. 6, a path is set from the WWN 1 of the Host 1 through the WWN 5 to the LU 1 of the SUB 1. In this case, the application program 405 of the Host 1 can access the LU 1 through the WWN 1 and the WWN 5. For example, when the application program 405 of the Host 1 issues a data writing request to the LU 1, the request and data are transmitted from the WWN 1 to the WWN 5. Then, the data is stored in the LDEV 1 or 2 assigned to the LU 1.

Similarly, in the example of FIG. 6, a path is set from the WWN 2 of the Host 1 through the WWN 6 to the LU 2 of the SUB 1. A path is set from the WWN 3 of the Host 2 through the WWN 6 to the LU 2 of the SUB 1. A path is set from the WWN 3 of the Host 2 through the WWN 9 to the LU 1 and the LU 2 of the SUB 2. A path is set from the WWN 4 of the Host 2 through the WWN 9 to the LU 1 and the LU 2 of the SUB 2.

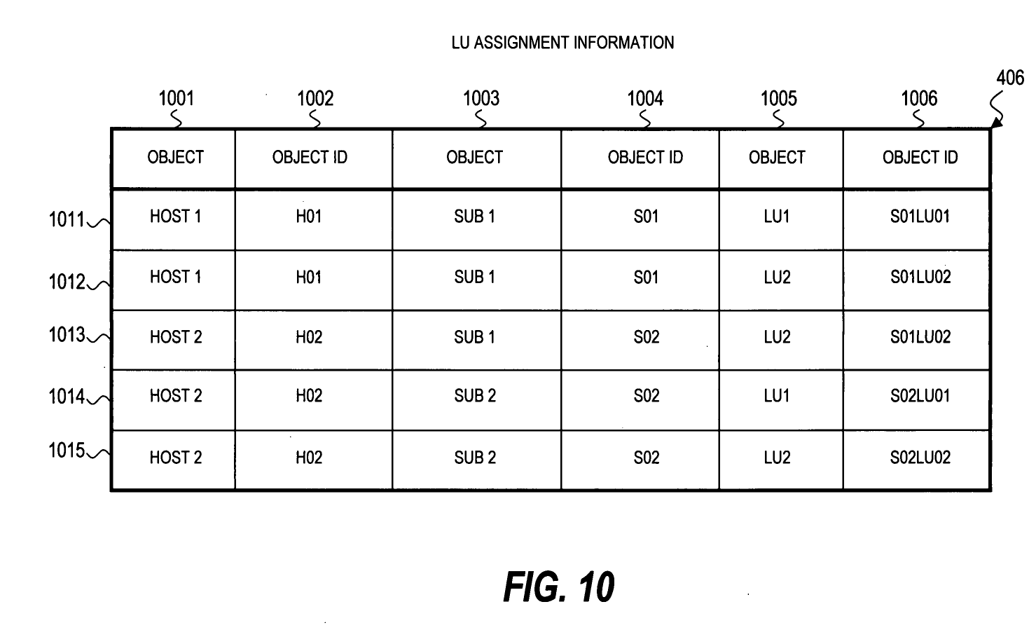

It should be noted that the LU 602 accessed by the host 120 is defined based on the LU assignment information 406 shown in FIG. 10.

As described above, when a path is set between the host 120 and the LU 601, and LDEV 602 is assigned to the LU 601, these objects are related to each other. For example, in FIG. 6, the Host 1 is a parent object of the LU 1 of the SUB 1, and the LU 1 of the SUB 1 is a child object of the Host 1. The LU 1 of the SUB 1 is a parent object of the LDEV 1 and the LDEV 2 of the SUB 1, and the LDEV 1 and the LDEV 2 of the SUB 1 are child objects of the LU 1 of the SUB 1.

FIGS. 7A and 7B are explanatory diagrams of information which the collection program 305 obtains from the host 120 according to the embodiment of this invention.

FIG. 7A shows information which the collection program 305 obtains from the Host 1 of FIG. 6 to store it in the database 306. This information contains a host name 701 and WWN 702. In the host name 701, a host name “Host 1” of the Host 1 is registered. In the WWN 702, WWN's “WWN 1” and “WWN 2” of the I/F 403 disposed in the Host 1 are registered corresponding to the Host 1.

FIG. 7B shows information which the collection program 305 obtains from the Host 2 of FIG. 6 to store it in the database 306. As in the case of FIG. 7A, the information contains a host name 701 and WWN 702. In the host name 701, a host name “Host 2” of the Host 2 is registered. In the WWN 702, WWN's “WWN 3” and “WWN 4” of the I/F 403 disposed in the Host 2 are registered corresponding to the Host 2.

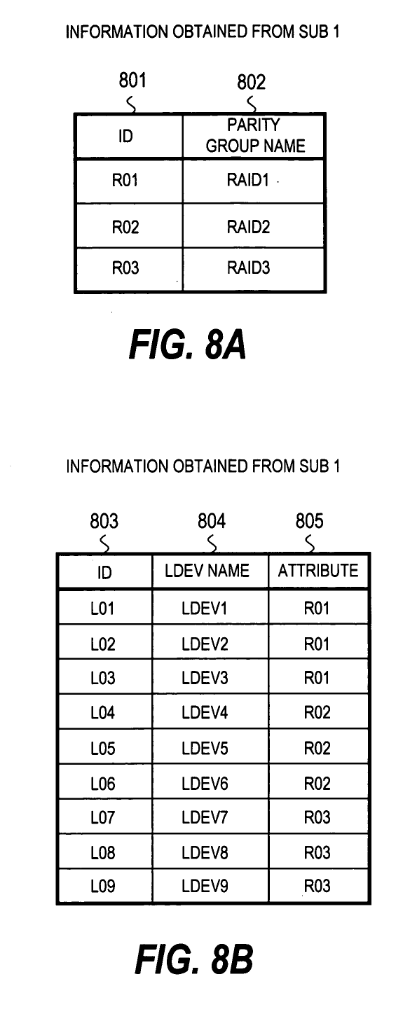

FIGS. 8A and 8B are explanatory diagrams of information which the collection program 305 obtains from the subsystem 140 according to the embodiment of this invention.

FIGS. 8A and 8B are explanatory diagrams of information which the collection program 305 obtains from the SUB 1 of FIG. 6.

FIG. 8A shows information regarding each parity group 143. The information contains an ID 801 and a parity group name 802. The ID 801 is an identifier of each parity group 143. The parity group name 802 is a parity group name of each parity group 143.

In an example of FIG. 8A, “R01”, “R02”, and “R03” are registered as ID's 801, and “RAID 1”, “RAID 2”, and “RAID 3” are registered as corresponding parity group name 802. This shows that identifiers “R01”, “R02”, and “R03” are given to the RAID 1, RAID 2, and RAID 3, respectively.

FIG. 8B shows information regarding each LDEV 602. This information contains an ID 803, an LDEV name 804, and an attribute 805. The ID 803 is an identifier of each LDEV 602. The LDEV name 804 is an LDEV name of each LDEV 602. The attribute 805 is an ID 801 of the parity group 143 including each LDEV 602.

In an example of FIG. 8B, “L01” to “L09” are registered as ID's 803, and “LDEV 1” to “LDEV 9” are registered as corresponding LDEV names 804. Additionally, “R01” is registered as attributes 805 corresponding to the “LDEV 1” to the “LDEV 3”, “R02” is registered as attributes 805 corresponding to the “LDEV 4” to the “LDEV 6”, and “R03” is registered as attributes 805 corresponding to the “LDEV 7” to the “LDEV 9”. This shows that identifiers “L01” to “L09” are given to the LDEV's 1 to 9, respectively. In the example of FIG. 8B, the LDEV's 1 to 3 are included in RAID 1, the LDEV's 4 to 6 are included in RAID 2, and the LDEV's 7 to 9 are included in RAID 3.

In the example of FIG. 6, the SUB 2 includes a parity group 143 and an LDEV 602 similar to those of the SUB 1. Accordingly, information that the collection program 305 obtains from the SUB 2 is similar to that obtained from the SUB 1 shown in FIGS. 8A and 8B. Thus, the information that the collection program 305 obtains from the SUB 2 is not shown.

FIGS. 9A and 9B are explanatory diagrams of LDEV assignment information 504 according to the embodiment of this invention.

The LDEV assignment information 504 is created by the management server 110 based on the pieces of information collected by the collection program 305 shown in FIGS. 7A and 7B and FIGS. 8A and 8B, and transmitted from the management server 110 to the subsystem 140 through the IP network 150. The controller 141 of the subsystem 140 stores the received LDEV assignment information 504 in the memory 503. Subsequently, the controller 141 refers to the LDEV assignment information 504 to manage the LU 601 and the LDEV 602. Specifically, upon reception of a request of accessing the LU 601 from the host 120, the controller 141 refers to the LDEV assignment information 504 to write data in the LDEV 602 corresponding to the LU 601 or read data from the LDEV 602.

FIG. 9A shows LDEV assignment information 504 of the SUB 1 of FIG. 6.

The LDEV assignment information 504 contains an object 901, an object ID 902, an attribute 903, an object 904, and an object ID 905.

The object 901 is an LDEV name of the LDEV 602 assigned to the LU 601. In the example of FIG. 6, in the SUB 1, the LDEV 1, the LDEV 2, and the LDEV 3 are assigned to the LU 1 or the LU 2. Accordingly, “LDEV 1”, “LDEV 2”, and “LDEV 3” are registered in the object 901.

The object ID 902 is a unique identifier given to the LDEV 602 assigned to the LU 601 in the computer system. In an example of FIG. 9A, “S01R01L01”, “S01R01L02”, and “S01R01L03” are registered as object ID's 902 corresponding to the LDEV's 1 to 3 of the SUB 1.

The attribute 903 is an ID 801 of a parity group 143 including the LDEV 602 assigned to the LU 601. In the example of FIG. 6, the LDEV 1, the LDEV 2, and the LDEV 3 are included in the RAID 1. Accordingly, “R01” is registered as the attribute 903 corresponding to the LDEV 1, the LDEV 2, and the LDEV 3.

The object 904 is an LU name of the LU 601 to which the LDEV 602 is assigned. In the example of FIG. 6, in the SUB 1, the LDEV 1 and the LDEV 2 are assigned to the LU 1, and the LDEV 3 is assigned to the LU 2. Accordingly, “LU 1” is registered as the object 904 corresponding to the LDEV 1 and the LDEV 2. “LU 2” is registered as the object 904 corresponding to the LDEV 3.

The object ID 905 is a unique identifier given to the LU 601 in the computer system. In the example of FIG. 9A, “S01LU01” and “S01LU02” are registered as object ID's 905 corresponding to the LU 1 and the LU 2 of the SUB 1.

FIG. 9B shows LDEV assignment information 504 of the SUB 2 of FIG. 6. In FIG. 9B, portions similar to those of FIG. 9A will not be described.

In the example of FIG. 6, in the SUB 2, the LDEV 5, the LDEV 2, and the LDEV 3 are assigned to the LU 1 or the LU 2. Accordingly, “LDEV 5”, “LDEV 2”, and “LDEV 3” are registered in the object 901.

In the example of FIG. 9B, “S02R02L05”, “S02R01L02”, and “S02R01L03” are registered as object ID's 902 corresponding to the LDEV 5, the LDEV 2, and the LDEV 3 of the SUB 2.

In the example of FIG. 6, the LDEV 5 is included in the RAID 2, while the LDEV 2 and the LDEV 3 are included in the RAID 1. Accordingly, “R02”, “R01”, and “R01” are registered as attributes 903 corresponding to the LDEV 5, the LDEV 2, and the LDEV 3.

In the example of FIG. 6, in the SUB 2, the LDEV 5 is assigned to the LU 1, and the LDEV 2 and LDEV 3 are assigned to the LU 2. Accordingly, “LU 1” is registered as the object 904 corresponding to the LDEV 5. “LU 2” is registered as the object 904 corresponding to the LDEV 2 and LDEV 3.

In the example of FIG. 9B, “S02LU01” and “S02LU02” are registered as object ID's 905 corresponding to the LU 1 and the LU 2 of the SUB 2.

FIG. 10 is an explanatory diagram of LU assignment information 406 according to the embodiment of this invention.

The LU assignment information 406 is created by the management server 110 based on the pieces of information obtained by the collection program 305 shown in FIGS. 7A and 7B and FIGS. 8A and 8B, and transmitted from the management server 110 to the host 120 through the IP network 150. The host 120 stores the received LU assignment information 406 in the memory 404. Subsequently, the host 120 refers to the LU assignment information 406 to manage access to the LU 601. Specifically, the host 120 refers to the LU assignment information 406 to transmit an accessing request issued by the application program 405 to the LU 601 assigned to the host 120.

FIG. 10 shows LU assignment information 406 of the host 120 of FIG. 6.

The LU assignment information 406 contains an object 1001, an object ID 1002, an object 1003, an object ID 1004, an object 1005, and an object ID 1006.

The object 1001 is a host name of the host 120 to which the LU 601 is assigned. The object ID 1002 is a unique identifier given to each host 120 in the computer system. In an example of FIG. 10, identifiers “H01” and “H02” are given to the Host 1 and the Host 2 respectively.

The object 1003 is a subsystem name of the subsystem 140 which includes the LU 601 assigned to the host 120. The object ID 1004 is a unique identifier given to each subsystem 140 in the computer system. In the example of FIG. 10, identifiers “S01” and “S02” are given to the SUB 1 and the SUB 2 respectively.

The object 1005 is an LU name of the LU 601 assigned to the host 120. The object ID 1006 is a unique identifier given to each LU 601 in the computer system. In the example of FIG. 10, identifiers “S01LU01” and “S01LU02” are given to the LU 1 and the LU 2 of the SUB 1 respectively. Identifiers “S02LU01” and “S02LU02” are given to the LU 1 and the LU 2 of the SUB 2 respectively.

In the LU assignment information 406, one line (entry) corresponds to one path from the host 120 to the LU 601. In the example of FIG. 6, there are five paths set from the host 120 to the LU 601. Thus, the LU assignment information 406 of FIG. 10 is constituted of five lines.

A line 1011 corresponds to a path from the WWN 1 of the Host 1 through the WWN 5 to the LU 1 of the SUB 1. Accordingly, the Host 1, the SUB 1, and the LU 1 are registered as objects 1001, 1003, and 1005 in the line 1011 respectively.

A line 1012 corresponds to a path from the WWN 2 of the Host 1 through the WWN 6 to the LU 2 of the SUB 1. Accordingly, the Host 1, the SUB 1, and the LU 2 are registered as objects 1001, 1003, and 1005 in the line 1012 respectively.

A line 1013 corresponds to a path from the WWN 3 of the Host 2 through the WWN 6 to the LU 2 of the SUB 1. Accordingly, the Host 2, the SUB 1, and the LU 2 are registered as objects 1001, 1003, and 1005 in the line 1013 respectively.

A line 1014 corresponds to a path from the WWN 3 of the Host 2 through the WWN 9 to the LU 1 of the SUB 2. Accordingly, the Host 2, the SUB 2, and the LU 1 are registered as objects 1001, 1003, and 1005 in the line 1014 respectively.

A line 1015 corresponds to a path from the WWN 4 of the Host 2 through the WWN 9 to the LU 2 of the SUB 2. Accordingly, the Host 2, the SUB 2, and the LU 2 are registered as objects 1001, 1003, and 1005 in the line 1015 respectively.

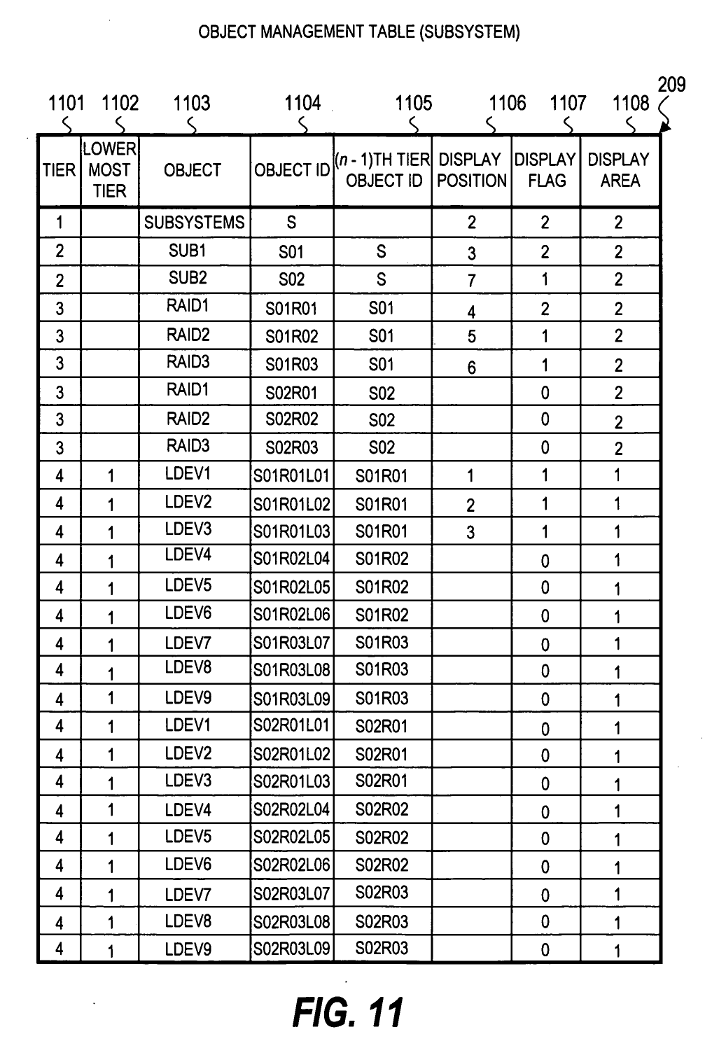

FIG. 11 is an explanatory diagram of an object management table 209 regarding the subsystem 140 according to the embodiment of this invention.

The object management table 209 is created by the administrator PC 100 based on the information obtained by the collection program 305, and stored in the memory 206. An object display program 207 refers to the object management table 209 to execute object displaying shown in FIG. 16.

As shown in FIG. 2, the object management table 209 is stored in the memory 206 of the administrator PC 100 of the embodiment. When a plurality of root objects are present in the computer system, object management tables 209 the number of which is equal to that of root objects is stored in the memory 206.

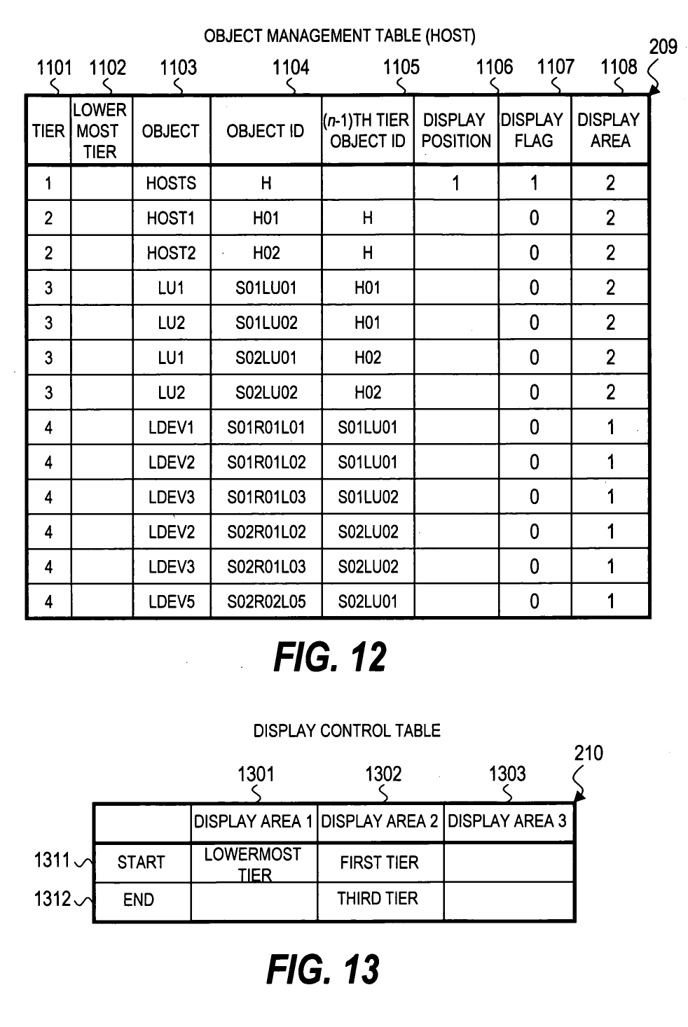

The root object is an uppermost object displayed on the screen of the output device 202. According to the embodiment shown in FIGS. 1 and 6, “Hosts” of a category including the hosts 120, and “Subsystems” of a category including the subsystems 140 are root objects. Thus, in the memory 206 of the embodiment, two object management tables 209 are stored. FIG. 11 shows, of those tables, an object management table 209 regarding subsystems (i.e., object management table 209 having “Subsystems” as a root object). FIG. 12 described below shows an object management table 209 regarding hosts.

The object management table 209 contains a tier 1101, a lowermost tier 1102, an object 1103, an object ID 1104, an (n−1)th tier object ID 1105, a display position 1106, a display flag 1107, and a display area 1108. One line of the object management table 209 corresponds to one object.

The tier 1101 indicates a tier decided based on a parent-child relation of objects. A child object is lower by one in a tier structure than its parent object. As an object is lower in a tier structure, a value of the tier 1101 is larger. For example, the tier 1101 of a root object is “1”, the tier 1101 of its child object is “2”, and the tier 1101 of its child object is “3”.

The lowermost tier 1102 is a flag to indicate whether each object has a child object or not. When a lowermost tier 1102 of a certain object is blank, the object has a child object. In other words, there is an object in which the object is a parent object. On the other hand, when a lowermost tier 1102 of a certain object is “1”, the object has no child objects. In other words, there are no objects where the object is a parent object. Such an object is described as an object of a lowermost tier.

The object 1103 is an object name of an object corresponding to each line of the object management table 209. The object 1103 of the subsystem that is a root object is “Subsystems”. The object 1103 of each subsystem 140 is a subsystem name. The object 1103 of each parity group 143 is a parity group name. The object 1103 of each LDEV 602 is an LDEV name (see FIG. 6).

The object ID 1104 is a unique identifier of an object corresponding to the object 1103 in the computer system.

The object ID 1104 of the subsystem that is a root object is “S”.

The object ID's 1104 of the SUB 1 and the SUB 2 are respectively “S01” and “S02”.

The object ID's 1104 of the RAID 1, the RAID 2, and the RAID 3 of the SUB 1 are respectively “S01R01”, “S01R02”, and “S01R03”. The object ID's 1104 of the RAID 1, the RAID 2, and the RAID 3 of the SUB 2 are respectively “S02RO1”, “S02R02”, and “S02R03”.

The object ID's 1104 of the LDEV's 1 to 3 included in the RAID 1 of the SUB 1 are “S01R01L01” to “S01R01L03” respectively. The object ID's 1104 of the LDEV's 4 to 6 included in the RAID 2 of the SUB 1 are “S01R02L04” to “S01R02L06” respectively. The object ID's 1104 of the LDEV's 7 to 9 included in the RAID 3 of the SUB 1 are “S01R03L07” to “S01R03L09” respectively.

The object ID's 1104 of the LDEV's 1 to 3 included in the RAID 1 of the SUB 2 are “S02R01L01” to “S02R01L03” respectively. The object ID's 1104 of the LDEV's 4 to 6 included in the RAID 2 of the SUB 2 are “S02R02L04” to “S02R02L06” respectively. The object ID's 1104 of the LDEV's 7 to 9 included in the RAID 3 of the SUB 2 are “S02R03L07” to “S02R03L09” respectively.

The (n−1)th tier object ID 1105 is an object ID 1104 of an object of a tier higher by one than that of each object.

Values of the tier 1101 to the (n−1)th tier object ID 1105 of the object management table 209 of FIG. 11 correspond to the computer system shown in FIG. 6. For example, the SUB 1 is present as a subsystem 140, the SUB 1 includes RAID 1, the RAID 1 includes LDEV 1, and the LDEV 1 has no child objects.

The display position 1106 is represented by coordinates when each object is displayed in the output device 202. Those coordinates will be described below in detail.

The display flag 1107 indicates a displayed state of each object.

An object having a display flag 1107 of “0” is outside a target of displaying. In other words, such an object is not displayed in the output device 202.

An object having a display flag 1107 of “1” is normally displayed in the output device 202. The normal displaying means a nonhighlighted state of an object.

An object having a display flag 1107 of “2” or “3” is highlighted in the output device 202. The highlighted displaying means that a target object is displayed in a form different from that of a normally displayed object to be visually distinguished from the normally displayed object. For example, the highlighted object may be displayed in a graphic of a shape, a size, or a color different from that of the normally displayed object. Alternatively, the normally displayed object may be displayed in a character of a usual font, while the highlighted object may be displayed in a bold face or reversed character. Otherwise, the highlighted object may be displayed in a flashing graphic. The highlighted object may be displayed in other forms different from that of the normal displaying.

For the highlighted object, there are two kinds of objects, i.e., an object displayed with selection highlighting, and an object displayed with relation highlighting. The object having the display flag 1107 of “2” is an object displayed with selection highlighting, while the object having the display flag 1107 of “3” is an object displayed with relation highlighting.

The object displayed with selection highlighting and the object displayed with relation highlighting are displayed in different forms (e.g., different graphics or colors) to be visually distinguished from each other.

When the system administrator selects a certain object, and instructs to display a child object of the selected object in the output device 202, the selected object is displayed with selection highlighting.

When the system administrator selects a certain object, and instructs to display all upper objects related to the selected object, all the upper objects are displayed with relation highlighting.

The display area 1108 is an area to display each object in the output device 202. The area in the output device of the embodiment is divided into two areas, i.e., first and second areas. Alternatively, the area in the output device 202 may be divided into three areas, i.e., first to third areas. An object whose display area 1108 is “1” is displayed in the first area. An object whose display area 1108 is “2” is displayed in the second area. An object whose display area 1108 is “3” is displayed in the third area. Those areas will be described below in detail.

FIG. 12 is an explanatory diagram of an object management table 209 regarding the host 120 according to the embodiment of this invention.

The object management table 209 regarding the host 120 contains a tier 1101, an lowermost tier 1102, an object 1103, an object ID 1104, an (n−1)th tier object ID 1105, a display position 1106, a display flag 1107, and a display area 1108. Portions similar to those of FIG. 11 will not be described.

The object 1103 as a root object is “Hosts”. The object 1103 of the host 120 is a host name. The object 1103 of each LU 601 is an LU name. The object 1103 of each LDEV 602 is a an LDEV name shown in FIG. 6.

The object ID 1104 of the host that is a root object is “H”.

The object ID's 1104 of the Host 1 and the Host 2 are respectively “H01” and “H02”.

The object ID's 1104 of the LU 1 and the LU 2 of the SUB 1 are respectively “S01LU01”, and “S01LU02”. The object ID's 1104 of the LU 1 and the LU 2 of the SUB 2 are respectively “S02LU01” and “S02LU02”.

The object ID's 1104 of the LDEV's 1 to 3 of the SUB 1 are respectively “S01R01L01”, “S01R01L02”, and “S01R01L03”. The object ID's 1104 of the LDEV's 2, 3, and 5 of the SUB 2 are respectively “S02R01L02”, “S02R01L03”, and “S02R02L05”.

FIG. 13 is an explanatory diagram of a display control table 210 according to the embodiment of this invention.

The display control table 210 defines a correlation between a tier of an object and an area for displaying the object. Specifically, a range of tiers displayed in each display area is defined.

In an example of FIG. 13, “lowermost tier” is registered corresponding to “start (line 1311)” of “display area 1” (column 1301). On the other hand, nothing is registered corresponding to “end” (line 1312) of the “display area 1” (column 1301). This means that objects of a lowermost tier (i.e., objects having a lowermost tier 1102 of the object management table 209 set to “1”) alone are displayed in the display area 1. “First tier” is registered corresponding to “start” (line 1311) of “display area 2” (column 1302), and “third tier” is registered corresponding to “end” (line 1312) of the “display area 2” (column 1302). This means that objects of the first to the third tiers (i.e., objects having tiers of the object management table 209 set to “1”, “2”, and “3”) alone are displayed in the display area 2.

In the example of FIG. 13, nothing is registered corresponding to “display area 3” (line 1303). This means that there is no display area 3.

The object display program 207 refers to the display control table 210 to judge which display area an object will be displayed in.

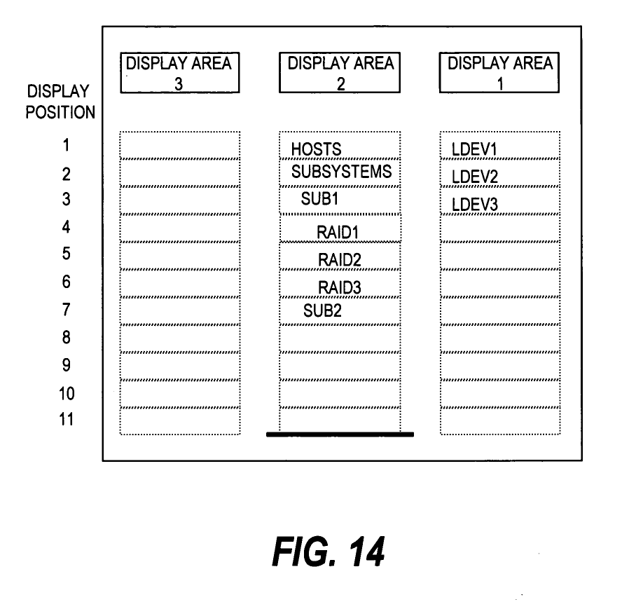

FIG. 14 is an explanatory diagram of the display memory 211 according to the embodiment of this invention.

The display memory 211 stores contents to be displayed in the output device 202. Specifically, the display memory 211 stores contents to be displayed in each display position of the display area. FIG. 14 shows an example of contents of the display memory 211 where the object management tables 209 are as shown in FIGS. 11 and 12 and the display control table 210 is as shown in FIG. 13.

Areas of the display memory 211 include areas corresponding to the display areas 1 to 3, and each of those areas includes an area corresponding to each display position. In those areas, object names of objects to be displayed in the output device 202 are stored by the object display program 207.

As shown in FIGS. 11 and 12, the display flags 1107 of the Subsystems, the SUB 1, the SUB 2, the RAID 1 to the RAID 3, the LDEV 1 to the LDEV 3, and the Hosts are “1” or “2”. In other words, as those objects are display targets, object names thereof are stored in the display memory 211.

As shown in FIGS. 11 and 12, the display areas 1108 of the Subsystems, the SUB 1, the SUB 2, the RAID 1 to the RAID 3, and the Hosts are “2”. Accordingly, object names of those objects are stored in areas corresponding to the display area 2 of the display memory 211. On the other hand, the display areas 1108 of the LDEV 1 to the LDEV 3 are “1”. Thus, object names of those objects are stored in areas corresponding to the display area 1 of the display memory 211.

As shown in FIGS. 11 and 12, the display positions 1106 of the Hosts, the Subsystems, the SUB 1, the RAID 1, the RAID 2, the RAID 3, and the SUB 2 are respectively “1”, “2”, “3”, “4”, “5”, “6”, and “7”. Accordingly, object names of those objects are stored in areas corresponding to the display positions of the display memory 211.

As shown in FIG. 11, the display positions 1106 of the LDEV 1 to the LDEV 3 are respectively “1”, “2”, and “3”. Accordingly, object names of those objects are stored in areas corresponding to the display positions of the display memory 211.

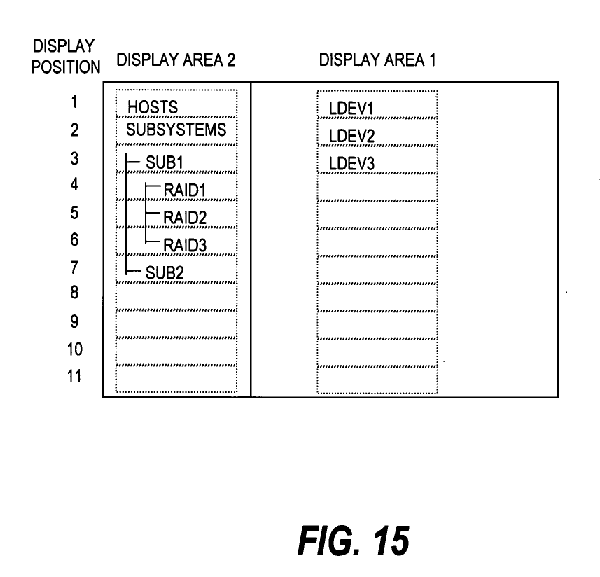

FIG. 15 is an explanatory diagram of a screen displayed in the output device 202 according to the embodiment of this invention.

FIG. 15 shows an example of a screen which the drawing processor 204 displays by referring to the display memory 211 of FIG. 14.

As shown in FIG. 15, the screen displayed in the output device 202 is divided into two left and right areas. The right area is a display area 1, and the left area is a display area 2. In this example, there is no display area 3. “Hosts”, “Subsystems”, “SUB 1”, “RAID 1”, “RAID 2”, “RAID 3”, and “SUB 2” are displayed in the display positions 1 to 7 of the display area 2 according to the display memory 211 shown in FIG. 14. Further, “LDEV 1” to “LDEV 3” are displayed in the display positions 1 to 3 of the display area 1.

A broken-line frame around each object name is shown to clarify correspondence between each object name and a display position. Accordingly, such a frame does not need to be displayed in a real output device 202.

As shown in FIG. 11, the display flags 1107 of the Subsystems, the SUB 1, and the RAID 1 are “2”. Thus, in FIG. 15, “Subsystems”, “SUB 1”, and RAID 1 are displayed with selection highlighting. In the example of FIG. 15, those are indicated by bold faces. This means that Subsystems as root objects are selected to display their child objects SUB 1 and SUB 2, the SUB 1 is selected to display its child objects RAID 1 to RAID 3, and the RAID 1 is selected to display its child objects LDEV 1 to LDEV 3.

Next, a process executed by the object display program 207 of the embodiment will be described. As described above, the object display program 207 is executed by the CPU 203 of the administrator PC 100. Thus, in the description below, the process executed by the object display program 207 will actually be executed by the CPU 203.

FIG. 16 is a flowchart of an object display process executed by the object display program 207 according to the embodiment of this invention.

The object display program 207 first judges whether there is an instruction input by the system administrator or not (1601). For example, the instruction inputting is an operation to designate a point on the screen of the output device 202 by a pointing device included in the input device 201. More specifically, the system administrator may designate and click a certain point on the screen by the mouse.

If it is judged in the step 1601 that there is no instruction input, the object display program 207 returns to the step 1601 to wait for a next instruction input.

On the other hand, if it is judged in the step 1601 that there is an instruction input, the object display program 207 judges whether there is an instruction input target (i.e. a target designated by the instruction input) or not (1602). For example, when a place having nothing displayed, such as a background, is instructed (i.e. designated) by the pointing device, it is judged that there is no instruction input target. On the other hand, when a boundary line or the like of objects or display areas is instructed by the pointing device, it is judged that there is an instruction input target.

If it is judged in the step 1602 that there is no instruction input target, the object display program 207 returns to the step 1601 to wait for a next instruction input.

On the other hand, if it is judged in the step 1602 that when there is an instruction input target, the object display program 207 judges whether the instructed target (i.e. the target designated by the instruction input) is an object or not (1603).

If it is judged in the step 1603 that the instructed target is not an object, the object display program 207 executes a display changing process 1 (1606). According to the embodiment, the display changing processing 1 is executed to move a boundary line when the boundary line of objects is designated.

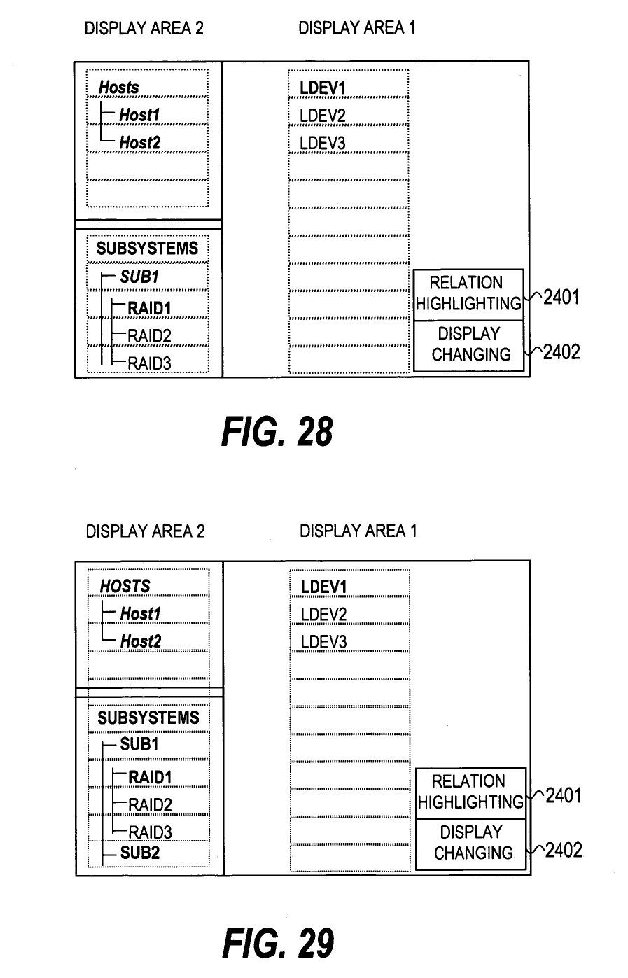

Now, the boundary line of the display areas will be described. As shown in FIG. 15, the screen displayed in the output device 202 of the embodiment is divided into respective display areas. Each display area may be further divided into two or more areas. The boundary line of the display areas is a boundary line when one display area is divided into two or more areas. An example of a screen in this case will be described below (see FIG. 28 or the like).

For example, in the display area 2 of FIG. 15, two root objects of “Hosts” and “Subsystems” are displayed. In this case, the display area 2 may be vertically divided into two areas. The Hosts and lower objects may be displayed in one of the areas, while the Subsystems and lower objects may be displayed in the other area. In this case, scrolling is executed independently in each area.

Thus, when one display area is further divided into two or more areas, the system administrator can move a boundary line of the display areas to an optional position. The display changing process 1 executed in the step 1606 of the embodiment moves the boundary line when the system administrator issues an instruction to move the boundary line to an optional position, and updates a display position of each object according to the moved boundary line.

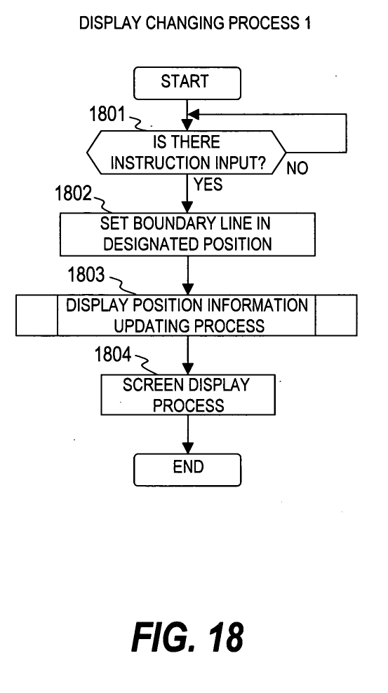

The display changing process 1 shown in FIG. 18 will be described below. When a target outside the boundary line of the display areas is instructed, another process may be executed. The object display program 207 executes the display changing process 1, and then returns to the step 1601 to wait for a next instruction input.

On the other hand, if it is judged in the step 1603 that the instructed target is an object, the object display program 207 judges whether there is an instruction input of relation highlighting or not (1604). For example, the instruction input of the relation highlighting is executed in a manner that the system administrator instructs “relation highlighting button” described below on the screen of the output device 202 by the pointing device.

If it is judged in the step 1604 that there is no instruction input of relation highlighting, the object display program 207 executes a display changing process 2 as relation highlighting is not required (1607).

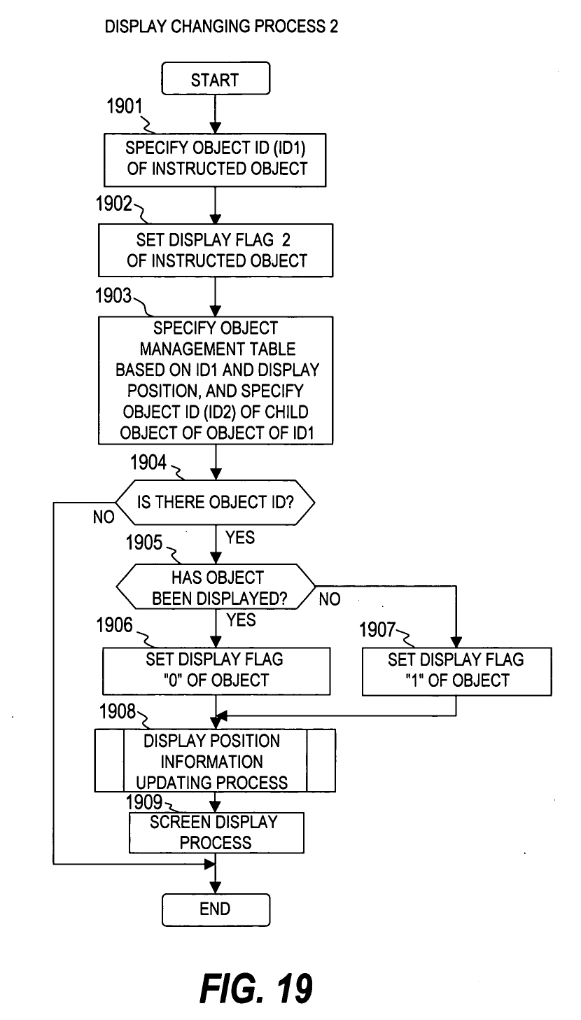

The display changing process 2 executes selection highlighting of the object instructed in the step 1601. When child objects of the instructed object have not been displayed, the child objects are displayed by the display changing process 2. Hereinafter, an object designated by the instruction input will be referred to as an instructed object. On the other hand, when the child objects of the instructed object have been displayed, the child objects are not displayed any more by the display changing process 2. The display changing process 2 shown in FIG. 19 will be described below in detail.

After the execution of the display changing process 2, the object display program 207 returns to the step 1601 to wait for a next instruction input.

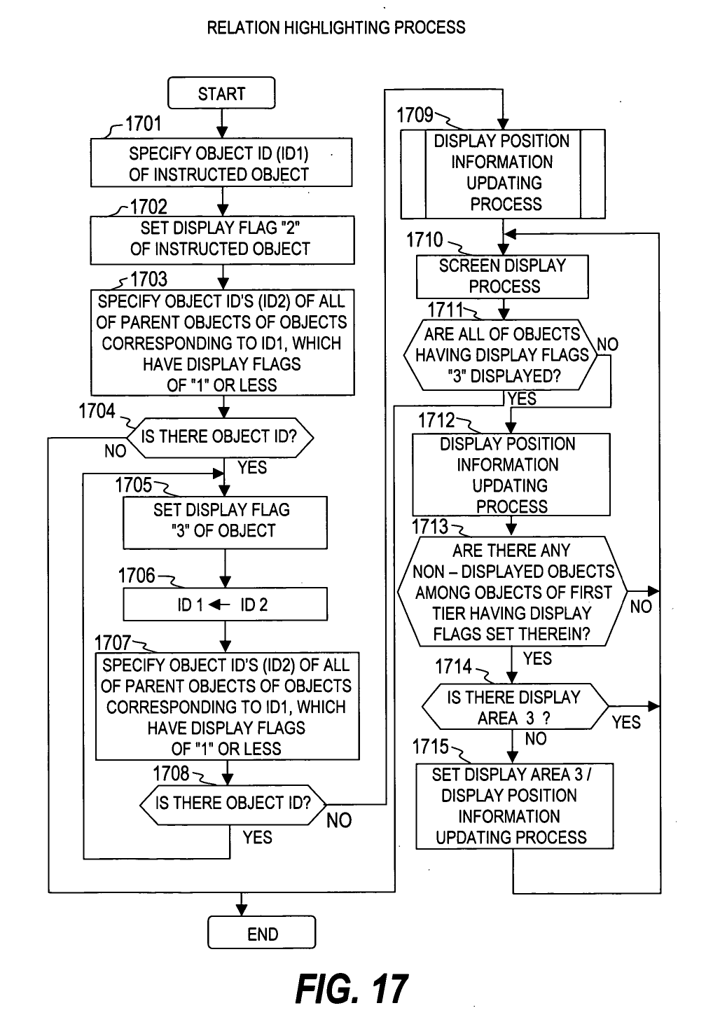

If it is judged in the step 1604 that there is an instruction input of relation highlighting, the object display program 207 is required to execute relation highlighting. In this case, the object display program 207 executes a relation highlighting process (1605). The relation highlighting process shown in FIG. 17 will be described below in detail. After the execution of the relation highlighting process, the object display program 207 returns to the step 1601 to wait for a next instruction input.

FIG. 17 is a flowchart of the relation highlighting process executed by the object display program 207 according to the embodiment of this invention.

This relation highlighting process is executed in the step 1605 of the object display process shown in FIG. 16.

Upon start of the relation highlighting process, the object display program 207 first specifies an object ID 1104 of an instructed object (1701). The instructed object means an object which becomes an instruction input target in the step 1601 of FIG. 16. This object ID 1104 will be referred to as ID 1 hereinafter.

Next, the object display program 207 sets a display flag 1107 corresponding to the instructed object to “2” in the object management table 209 (1702).

Then, the object display program 207 specifies an object ID 1104 of an object which has not been highlighted among parent objects of the object having the object ID 1104 of ID 1 (1703). When there are a plurality of object ID's 1104 which meet this condition, the object display program 207 specifies all the object ID's 1104 which meet this condition. The object ID 1104 specified here will be referred to as “ID 2”.

Specifically, the object display program 207 refers to the object management table 209 to retrieve all objects having object ID's 1104 set to ID 1. Then, the object display program 207 refers to an (n−1)th tier object ID 1105 of objects discovered as a result of the retrieval. The object display program 207 retrieves an object having a value equal to that of the (n−1)th tier object ID 1105 referred to as an object ID 1104. The object display program 207 refers to display flags 1107 of objects discovered as a result of the retrieval. The object display program 207 specifies all objects having display flags 1107 set equal to or less than “1” among the objects. Object ID's 1104 of the specified objects are ID 2.

For example, when the LDEV 1 of the SUB 1 is instructed in a step 1701, an object ID 1104 (ID 1) of the LDEV 1 is S0R01L01. In the object management table 209, there are registered two objects having object ID's 1104 set to S01R01L01 shown in FIGS. 11 and 12. The (n−1)th tier object ID's 1105 of these objects are respectively S01R01 shown in FIG. 11 and S01LU01 shown in FIG. 12. A display flag 1107 of the object RAID 1 having an object ID 1104 set to S01R01 is “2” shown in FIG. 11. On the other hand, a display flag 1107 of the object LU 1 having an object ID 1104 set to S01LU01 is “0” shown in FIG. 12. Accordingly, in a step 1703, the S01LU01 is specified, and set to ID 2.

Next, the object display program 207 judges whether there is an object ID 1104 specified in the step 1703 or not, in other words, whether an object ID 1104 of at least one object has been specified or not in the step 1703 (1704).

If it is judged in the step 1704 that there is no specified object ID 1104, a parent objects not highlighted yet is not present in the object having an object ID 1104 set to ID 1. In this case, as there is no target of relation highlighting, the object display program 207 finishes the relation highlighting process.

On the other hand, if it is judged in the step 1704 that there is a specified object ID 1104, a parent object not highlighted yet is present in the object having the object ID 1104 set to ID 1. In this case, to display the parent object with relation highlighting, the object display program 207 sets a display flag 1107 corresponding to the specified object ID 1104 (i.e., ID 2) to “3” (1705).

Next, the object display program 207 sets ID 2 as new ID 1 (1706). For example, when ID 1 is S01R01L01 immediately before the step 1706, and ID 2 is S01LU01, the S01LU01 becomes new ID 1 in the step 1706.

Then, the object display program 207 specifies an object ID 1104 not highlighted yet among parent objects of the objects having object ID's 1104 set to ID 1(1707). This process is similar to that of the step 1703, and thus description thereof will be omitted. The object ID 1104 specified here becomes new ID 2.

Subsequently, the object display program 207 judges whether there is an object ID 1104 specified in the step 1707 or not (1708).

If it is judged in the step 1708 that there is a specified object ID 1104, a parent object not highlighted yet is present in the object having the object ID 1104 set to ID 1. In this case, to display the parent object with relation highlighting, the process returns to the step 1705.

On the other hand, if it is judged in a step 1708 that there is no specified object ID 1104, a parent object not highlighted yet is not present in the object having the object ID 1104 set to ID 1. At a point of this time, there are no more objects to be targeted for relation highlighting. Accordingly, the object display program 207 next executes a display position information updating process (1709). Specifically, when an object to be displayed with relation highlighting is not displayed on the screen of the output device 202, the object display program 207 executes the display position information updating process to display the object on the screen.

For example, as described above with reference to the step 1703, when S01LU01 is specified as ID 2, an object LU 1 having an object ID 1104 set to S01LU01 is displayed with relation highlighting. However, when the LU 1 is not displayed on the screen as shown in FIG. 15, to display the LU 1 with relation highlighting, the Host 1 and the Host 2 that are child objects of the root object Hosts must be displayed, and the LU 1 and the LU 2 that are child objects of the Host 1 must be displayed. Thus, in the step 1709, the object to be displayed with relation highlighting is newly displayed.

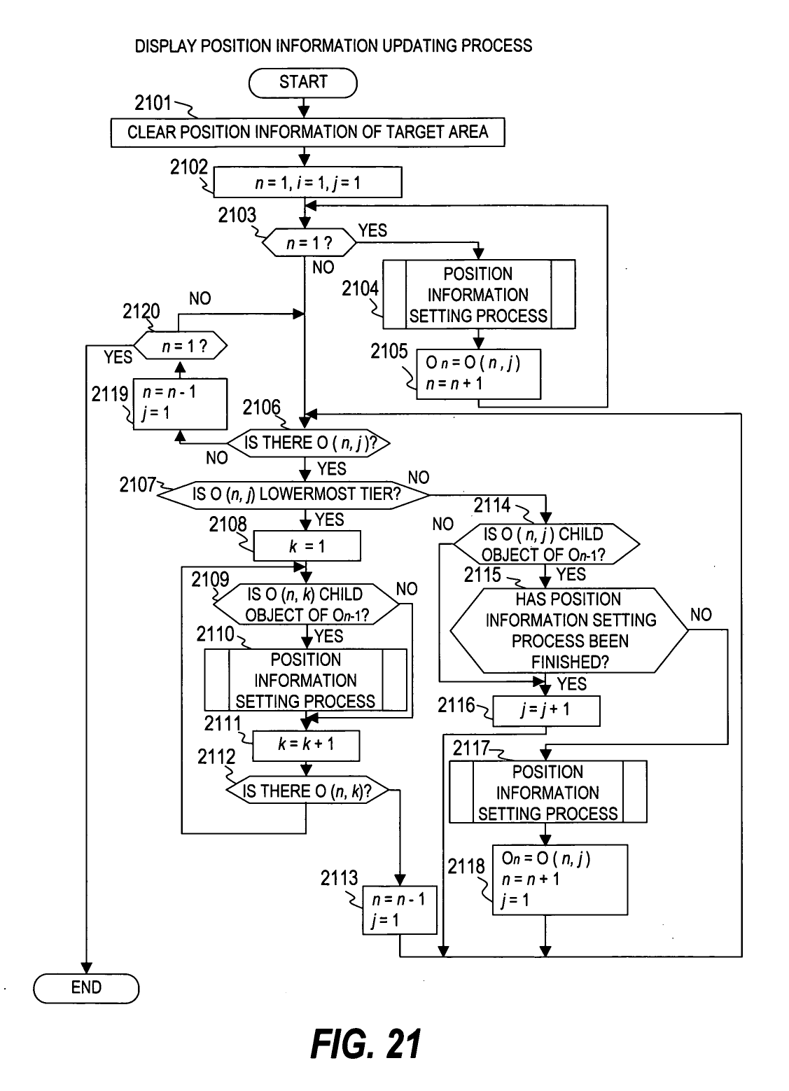

The display position information updating process executed here and shown in FIG. 21 or the like will be described below in detail. When the screen of the output device 202 is divided into a plurality of display areas, the display position information updating process shown in FIG. 21 or the like is executed for each display area. For example, as shown in FIG. 15, when the screen is divided into the display areas 1 and 2, the display position information updating process shown in FIG. 21 or the like is executed for an object where a display area 1108 of the object management table 209 shown in FIGS. 11 and 12 is set to “2”. Further, the display position information updating process is similarly executed for an object having a display area 1108 set to “1”.

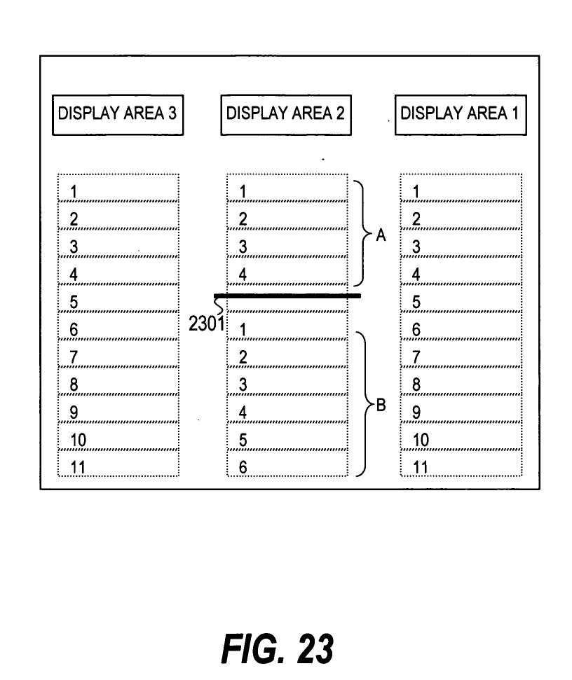

However, when one display area is further divided by a boundary line, the display position information updating process shown in FIG. 21 or the like is executed for each divided area shown in FIG. 23.

By the display position information updating process, display positions are updated for all the objects having display flags 1107 set to “1” or more.

Next, the object display program 207 executes a screen display process (1710). The screen display process is a process of displaying each object on the screen of the output device 202 according to position information set in the step 1709.

Subsequently, the object display program 207 judges whether all objects having display flags 1107 set to “3” (i.e., objects displayed with relation highlighting) are displayed or not on the screen (1711). When the number of objects increases in the computer system, all the objects cannot be simultaneously displayed on one screen. In this case, the screen must be scrolled to display all the objects. In the step 1711, judgment is made as to whether there is a relation highlighted object not displayed yet on the screen because of the impossibility of simultaneously displaying all the objects.

Specifically, when there is an object where a display flag 1107 of the object management table 209 is set to “3” and a value of a display position 1106 is larger than a maximum value (“11” in the example of FIG. 14) of the display position of the display memory 211, a relation highlighted object not displayed yet on the screen is judged to be present.

If it is judged in the step 1711 that the objects displayed with relation highlighting are all displayed on the screen, the object display program 207 finishes the relation highlighting process.

On the other hand, if it is judged in the step 1711 that the objects displayed with relation highlighting are not all displayed on the screen, at least one relation highlighted object is yet to be displayed on the screen. In this case, the object display program 207 executes a display position information updating process (1712).

In the step 1712, the object display program 207 may execute the display position information updating process, thereby automatically scrolling the screen of the output device 202 to display all the objects displayed with relation highlighting. Alternatively, the object display program 207 may sequentially scroll the screen according to a scrolling instruction input from the system administrator. For example, presuming that there are two relation highlighted objects which have not been displayed yet, scrolling may be executed until one of the relation highlighted objects is displayed when the system administrator inputs a scrolling instruction once. When the system administrator inputs another scrolling instruction, scrolling may be executed until the other relation highlighted object is displayed.

Specifically, in the step 1712, position information of each object (i.e., display position 1106 of the object management table 209) is updated. A value of the display position 1106 is sequentially decremented by 1, whereby a display position of each object is moved up on the screen.

In the step 1712, the position information of the object is updated, and then in the step 1710, screen displaying is updated according to the updated position information. As a result, scrolling is executed.

The scrolling in the steps 1712 and 1710 is executed until a value of a display position 1106 of an object having a largest display position 1106 among objects having display flags set to “3” becomes equal to or less than a maximum value of a display position of the display memory 211. As a result, all the relation highlighted objects are sequentially displayed on the screen.

Next, the object display program 207 judges whether objects of the first tier having display flags 1107 set to “1” or more include non-displayed objects or not (1713). The objects of the first tier are root objects. For example, in FIG. 15, when many objects are displayed below the SUB 2, the root objects (e.g., Hosts) are driven away to the outside of the screen by scrolling the screen to display the objects. As a result, some of the root objects may not be displayed on the screen. In the step 1713, judgment is made as to whether there are root objects not displayed in such a manner.

Specifically, when there is a root object where a display flag 1107 of the object management table 209 is equal to or greater than “1”, and a value of the display position 1106 is smaller than a minimum value of the display position of the display memory 211 (“1” in the example of FIG. 14), it is judged that there is a root object not displayed any more on the screen.

If it is judged in the step 1713 that there is no non-displayed object of a first tier, the process returns to the step 1710 to execute screen displaying according to the position information updated in the step 1712.

On the other hand, if it is judged in the step 1713 that there is non-displayed object of a first tier, the non-displayed object of the first tier is preferably displayed in the display area 3. It is because of desirability that the system administrator can easily understand all the root objects.

In this case, the display area 3 is disposed on the left side of the display area 2. As shown in FIG. 15, when there is no display area 3, a new display area 3 must be provided on the left side of the display area 2. Thus, the object display program 207 judges whether a display area 3 has been present or not (1714).

If it is judged in the step 1714 that there is a display area 3, the object display program 207 does not need to set any new display area 3. Accordingly, the process returns to the step 1710.

On the other hand, if it is judged in the step 1714 that there is no display area 3, the object display program 207 must set a new display area 3. Accordingly, the object display program 207 sets a new display area 3, and executes a display position information updating process (1715). In the step 1715, as in the case of the step 1709, the display position information updating process shown in FIG. 21 or the like is executed.

The object display program 207 updates the display control table 210 when setting the display area 3. In the example of FIG. 13, the first to third tiers are displayed in the display area 2. After the setting of the display area 3, “first tier” is registered in a line 1311 corresponding to the display area 3. This means that a new display area 3 is set in the screen of the output device 202 and the root object is displayed in the display area 3.

Subsequently, the object display program 207 returns to the step 1710 to execute screen displaying according to the position information updated in the steps 1712 and 1715.

The process of the steps 1711 to 1715 is summarized as follows.

When the display position 1106 of the object to be displayed with relation highlighting is larger than the maximum value of the display position of the display area, the object display program 207 decrements the value of the display position 1106 of each object until the display position 1106 of the object becomes equal to or less than the maximum value of the display position of the display area.

When the display position 1106 of the root object becomes smaller than the minimum value of the display position of the display area, the object display program 207 sets a new display area (display area 3) in the output device 202, and displays the root object in the newly set display area. More specifically, the object display program 207 registers the root object in the display control table corresponding to the new display area (display area 3), thereby setting the display area 3 in the output device 202.

FIG. 18 is a flowchart of the display changing process 1 executed by the object display program 207 according to the embodiment of this invention.

The display changing process 1 is executed in the step 1606 of the object display process shown in FIG. 16.

The object display program 207 first judges whether there is an instruction input from the system administrator (1801). For example, the instruction input means that the system administrator operates the pointing device included in the input device 201 to instruct setting of the boundary line of the display areas in an optional position.

If it is judged in the step 1801 that there is no instruction input, the object display program 207 returns to the step 1801 to wait for a next instruction input.

On the other hand, if it is judged in the step 1801 that there is an instruction input, the object display program 207 sets a boundary line in a position designated by the instruction input (1802). As a result, the boundary line is moved to the designated position.

Next, the object display program 207 executes a display information updating process (1803). By this display position information updating process, a display position of each object is updated according to the moved boundary line. In the step 1803, as in the case of the step 1709 of FIG. 17, the display position information updating process shown in FIG. 21 or the like is executed. However, to reduce a processing load, the display position information updating process shown in FIG. 21 or the like is executed by targeting a display area alone in which the boundary line has been set.

Next, the object display program 207 executes a screen display process (1804). This screen display process displays each object on the screen of the output device 202 according to the position information updated in the step 1803.

After the execution of the step 1804, the object display program 207 finishes the display changing process 1.

FIG. 19 is a flowchart of the display changing process 2 executed by the object display program 207 according to the embodiment of this invention.

The display changing process 2 is executed in the step 1607 of the object display process shown in FIG. 16.

Upon start of the display changing process 2, the object display program 207 first specifies an object ID 1104 of an instructed object (1901). The instructed object means an object which becomes an instruction input target in the step 1601 of FIG. 16. This object ID 1104 will be referred to as ID 1 hereinafter.

Next, the object display program 207 sets a display flag 1107 corresponding to the instructed object to “2” in the object management table 209 (1902).

Then, the object display program 207 specifies an object management table 209 based on the ID 1 and a display position of the instructed object (1903). In the memory 206, the number of object management tables 209 equal to that of root objects is stored. In the example of FIG. 6, there are an object management table 209 shown in FIG. 11 regarding the root objects “Subsystems” and an object management table 209 shown in FIG. 12 regarding the root objects “Hosts”. In the step 1903, it is specified which of the management tables the instructed object belongs to. For example, when the RAID 1 is designated in FIG. 15, in the step 903, the object management table 209 regarding the subsystems is specified.

Further, in the step 1903, the object display program 207 refers to the object management table 209 to specify an object ID 1104 of a child object of the instructed object. Specifically, the object management program 207 retrieves ID 1 in the (n−1)th tier object ID 1105 of the specified object management table 209. The object ID 1104 corresponding to the ID 1 discovered as a result is specified as an object ID 1104 of the child object of the instructed object. Hereinafter, the object ID specified in the step 1903 will be referred to as ID 2.

Next, the object display program 207 judges whether there is an object ID 1104 specified in the step 1903 or not, in other words, whether an object ID 1104 of at least one object has been specified or not in the step 1903 (1904).

If it is judged in the step 1904 that there is no specified object ID 1104, a child object of the instructed object is not present. In other words, as the child object of the instructed object cannot be displayed, the object display program 207 finishes the display changing process 2.

On the other hand, if it is judged in the step 1904 that there is a specified object ID 1104, one or more child objects of the instructed object are present. In this case, the object display program 207 judges whether the child objects have been displayed or not (1905).

If it is judged in the step 1905 that the child objects have been displayed, the object display program 207 cancels the displaying (1906). Specifically, the object display program 207 sets display flags 1107 of the child objects of the instructed object to “0”.

On the other hand, if it is judged in the step 1905 that the child objects have not been displayed, the object display program 207 displays the child objects (1907). Specifically, the object display program 207 sets display flags 1107 of the child objects of the instructed object to “1”.

Next, the object display program 207 executes a display position information updating process (1908). By this display position updating process, a display position of an object to be newly displayed is determined. Further, the display position of the object moved by new displaying or displaying cancellation of the object is updated. In the step 1908, as in the case of the step 1709 of FIG. 17, the display position information updating process shown in FIG. 21 or the like is executed.

Subsequently, the object display program 207 executes a screen display process (1909). This screen display process displays each object on the screen of the output device 202 according to the position information updated in the step 1908.

After the execution of the step 1909, the object display program 207 finishes the display changing process 2.

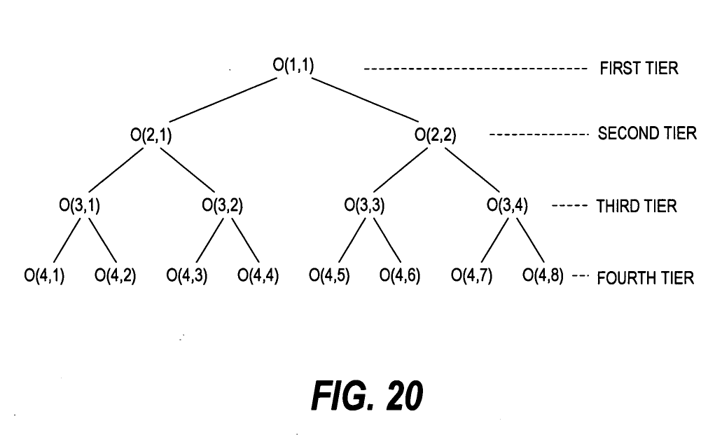

Next, referring to FIGS. 20 to 22, the display position information updating process will be described.

FIG. 20 is an explanatory diagram of a method of describing objects in the description of the display position information updating process according to the embodiment of this invention.

In the description below, a j-th object of an n-th tier will be described as O (n, j). O (1, 1) is a root object (i.e., first object of the first tier). O (2, 1) and O (2, 2) are child objects of the root object. O (3, 1) and O (3, 2) are child objects of the O (2, 1). O (4, 1) and O (4, 2) are child objects of the O (3, 1). An optional number of objects can be present in each tier except the first tier.

For example, in FIG. 11, the Subsystems is O (1, 1). The SUB 1 and the SUB 2 are respectively O (2, 1) and O (2, 2). The RAID 1 of the SUB 1 is O (3, 1). The LDEV 1 included in the RAID 1 of the SUB 1 is O (4, 1).

FIG. 21 is a flowchart of the display position information updating process executed by the object display program 207 according to the embodiment of this invention.

The display position information updating process is executed in the steps 1709 and 1715 of the relation highlighting process, the step 1803 of the display changing process 1, and the step 1908 of the display changing process 2 shown in FIGS. 17 to 19. The display position information updating process updates the position information of each object, i.e., the display position 1106 of each object.

Upon start of the display position information updating process, the object display program 207 first clears position information of a display area of a processing target (2101). Specifically, in the object management table 209, a display position 1106 of an object corresponding to a display area 1108 of a processing target is cleared.

Next, the object display program 207 initially sets values of n, i, and j to “1” (2102). In this case, n is a tier to which O (n, j) belongs, and j is a number of O (n, j) of the tier. On the other hand, i is a value to be set as a display position 1106 of O (n, j).

Next, the object display program 207 judges whether n=1 is established or not (2103).

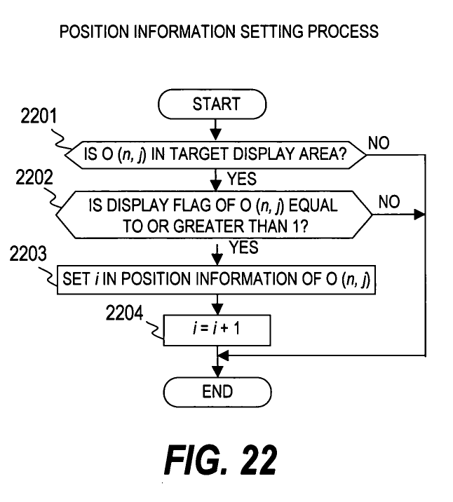

If n=1 is judged in the step 2103, the O (n,j) is a root object. In this case, the object display program 207 executes a position information setting process for the O (n, J) (2104). As a result, a display position 1106 of the O (n, j) is set to “i”, and subsequently a value of i is incremented by 1. The position information setting process executed in the step 2104 and subsequent steps 2110 and 2117 shown in FIG. 22 will be described below in detail.

Then, the object display program 207 sets On to O (n, j), and increments a value of n by 1 (2105). For example, when n=1 and j=1 are established, in the step 2105, O1 becomes O (1, 1), and n=2 is established.

After the execution of the step 2105, the object display program 207 returns to the step 2103 to process a next tier.

If it is judged that n=1 is not established in the step 2103, the O (n, j) is not a root object. In this case, the object display program 207 judges that there is O (n,j) (2106).

If it is judged in the step 2106 that there is O (n, j), the object display program 207 judges whether the O (n, j) is a lowermost tier or not (2107). Specifically, the object display program 207 judges whether a lowermost tier 1102 corresponding to the O (n, j) is “1” or not in the object management table 209.

If it is judged in the step 2107 that the O (n, j) is not a lowermost tier, the object display program 207 judges whether the O (n, j) is a child object of Om or not (2114), where m=n−1. For example, in the case of n=2, in the step 2114, judgment is made as to whether O (2, j) is a child object of O1 or not. The object display program 207 refers to the object ID 1104 and the (n−1)th tier object ID 1105 of the object management table 209 to execute the judgment of the step 2114.

If it is judged in the step 2114 that the O (n, j) is not a child object of Om, the process proceeds to a step 2116 described below.

On the other hand, if it is judged in the step 2114 that the O (n, j) is a child object of Om, the object display program 207 judges whether a position information setting process has been executed or not for the O (n, j) (2115).

If it is judged in the step 2115 that the position information setting process has been executed for the O (n, j), a display position 1106 has been set for the O (n, j). Accordingly, to set a display position 1106 of a next object of the same tier as that of the O (n, j), the object display program 207 increments a value of j by 1 (2116) to return to the step 2106.

On the other hand, if it is judged in the step 2115 that the position information setting process has not been executed for the O (n, J), a display position 1106 of the O (n, j) has not been set. Accordingly, the object display program 207 executes the position information setting process for the O (n, j) (2117). As a result, the display position 1106 of the O (n, J) is set to “i”, and subsequently a value of i is incremented by 1 as shown in FIG. 22.

Next, the object display program 207 sets On to O (n, j), and increments a value of n by 1 (2118). This is similar to the step 2105. Further, the object display program 207 sets a value of j to “1” in the step 2118. Then, the process returns to the step 2106.

If it is judged in the step 2107 that the O (n, j) is a lowermost tier, the object display program 207 sets a value of k to “1” (2108). In this case, k is a number in the tier of the object as in the case of j.

Next, the object display program 207 judges whether O (n, k) is a child object of Om or not (2109). As in the case of the step 2114, m=n−1 is established.

If it is judged in the step 2109 that the O (n, k) is not a child object of Om, the process proceeds to a step 2111 described below.

On the other hand, if it is judged in the step 2109 that the O (n, k) is a child object of Om, the object display program 207 executes a position information setting process for the O (n, k) (2110). As a result, a display position 1106 of the O (n, k) is set to “i”, and subsequently a value of i is incremented by 1 as shown in FIG. 22.

Next, the object display program 207 increments a value of k by 1 (2111).

Subsequently, the object display program 207 judges whether there is O (n, k) or not.

If it is judged in the step 2112 that there is O (n, k), there is a possibility that the n-th tier (lowermost tier) includes an object which is a child object of Om and for which a position information setting process has not been executed. Accordingly, the process returns to the step 2109.

On the other hand, if it is judged in the step 2112 that there is no O (n, k), a position information setting process has been executed for all the child objects of Om in the n-th tier. In this case, the object display program 207 decrements a value of n by 1, and sets a value of j to “1” (2113) to return to the step 2106.

If it is judged in the step 2106 that there is no O (n, j), the object display program 207 decrements a value of n by 1, and sets a value of j to 1 (2119).

Next, the object display program 207 judges whether n=1 is established or not (2120).

If it is judged that n=1 is not established in the step 2120, there is a possibility that there is an object having no display position 1106 set. Accordingly, to set a display position 1106 of the remaining objects, the process returns to the step 2106.

On the other hand, if it is judged that n=1 is established in the step 2120, display positions 1106 of all the objects have been set. Accordingly, the object display program 207 finishes the display position information updating process.

FIG. 22 is a flowchart of the position information setting process executed by the object display program 207 according to the embodiment of this invention.

The position information setting process is executed in the steps 2104, 2110, and 2117 of the display position information updating process shown in FIG. 21.

When the position information setting process is executed in the step 2110 of FIG. 21, a value of k is substituted for j in the process described below.

Upon start of the position information setting process, the object display program 207 judges whether the O (n, j) is in a target display area of the display position information updating process or not (2201). For example, when the display position information updating process by targeting the display area 2 is executed, the object display program 207 refers to the display control table 210 shown in FIG. 13 to judge whether or not n is any one of “1” to “3”. Alternatively, the object display program 207 may refer to the object management table 209 to judge whether a display area 1108 corresponding to the O (n, j) is “2” or not.

If it is judged in the step 2201 that the O (n, j) is not in the target display area of the display position information updating process, it is not necessary to update the display position 1106 of the O (n, j). Accordingly, the object display program 207 finishes the position information setting process.

On the other hand, if it is judged in the step 2201 that the O (n, j) is in the target display area of the display position information updating process, the object display program 207 refers to the object management table 209 to judge whether a display flag 1107 corresponding to the O (n, j) is greater than or equal to “1” (2202).

If it is judged in the step 2202 that the display flag 1107 corresponding to the O (n, j) is not greater than or equal to 1 (i.e., display flag 1107 is “0”), the O (n, j) is not a target of displaying on the screen. In this case, the object display program 207 does not need to update the display position 1106 of the O (n, j). Accordingly, the object display program 207 finishes the position information setting process.

On the other hand, if it is judged in the step 2202 that the display flag 1107 of the O (n, j) is greater than or equal to “1”, the O (n, j) is a target of displaying on the screen. In this case, the object display program 207 sets “i” as the display position 1106 of the O (n, j) (2203).

Next, the object display program 207 increments a value of i by 1 (2204). Then, the object display program 207 finishes the position information setting process.

The display position information updating process shown in FIG. 21 or the like is executed for each display area of the screen of the output device 202 as a target. However, when each display area is further divided by the boundary line, the display position information updating process shown in FIG. 21 or the like is executed for each divided area.

FIG. 23 is an explanatory diagram of the display memory 211 when the screen displayed in the output device 202 is divided according to the embodiment of this invention.

Portions of FIG. 23 similar to those of FIG. 14 will not be described.

In FIG. 23, a numeral in a broken-line frame indicates a display position of an object. For example, an object name of the object where a display position 1106 of the object management table 209 is “1” is stored in an area indicated by a frame “1”.

In an example of FIG. 23, a display area 2 is divided into two areas by a boundary line 2301. An area above the boundary line 2301 is a display area 2A, and an area below is a display area 2B. The display area 2 of the screen of the output device 202 is vertically divided by a boundary line. Then, an object name stored in the display area 2A of the display memory 211 is displayed in the area of the upper side of the display area 2 of the screen. On the other hand, an object name stored in the display area 2B of the display memory 211 is displayed in the area of the lower side of the display area 2 of the screen.

A display position of an area indicated by an uppermost frame of the display area 2A is “1”. Display positions of lower areas are assigned with larger values, such as “2”, “3”, and “4”.

A display position of an area indicated by an uppermost frame of the display area 2B is also “1”. Display positions of lower areas are assigned with larger values as in the case of the display area 2A.

Thus, when the display area 2 is divided into two, the display position information updating process shown in FIG. 21 or the like is executed for each of the display areas 2A and 2B.

Next, an example of a screen shown according to the embodiment will be described.

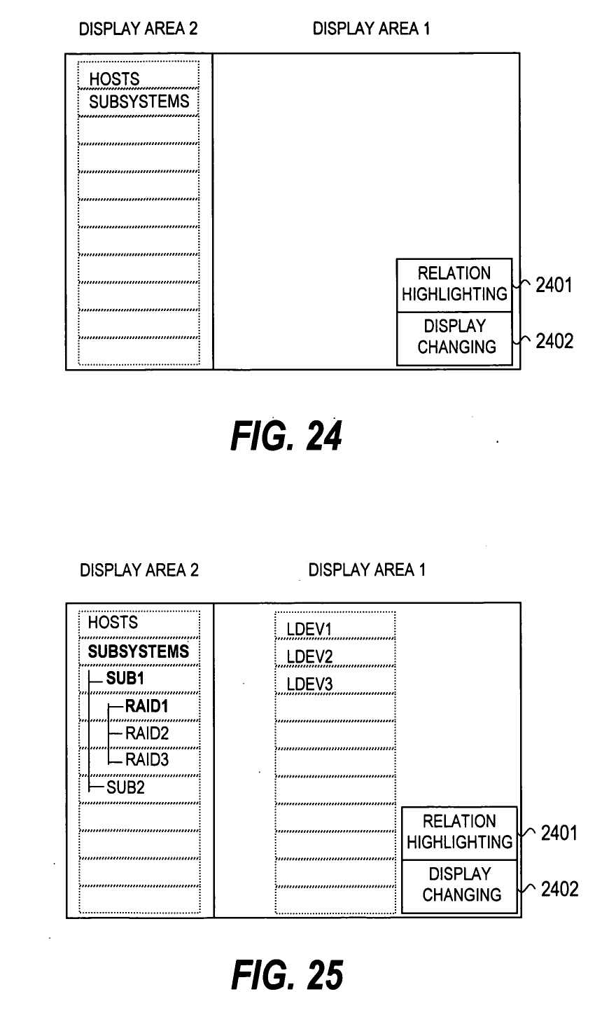

FIG. 24 is an explanatory diagram of an example of a screen displayed in the output device 202 according to the embodiment of this invention.

The screen shown in FIG. 24 includes display areas 1 and 2, and root objects “Hosts” and “Subsystems” alone are displayed in the display area 2.

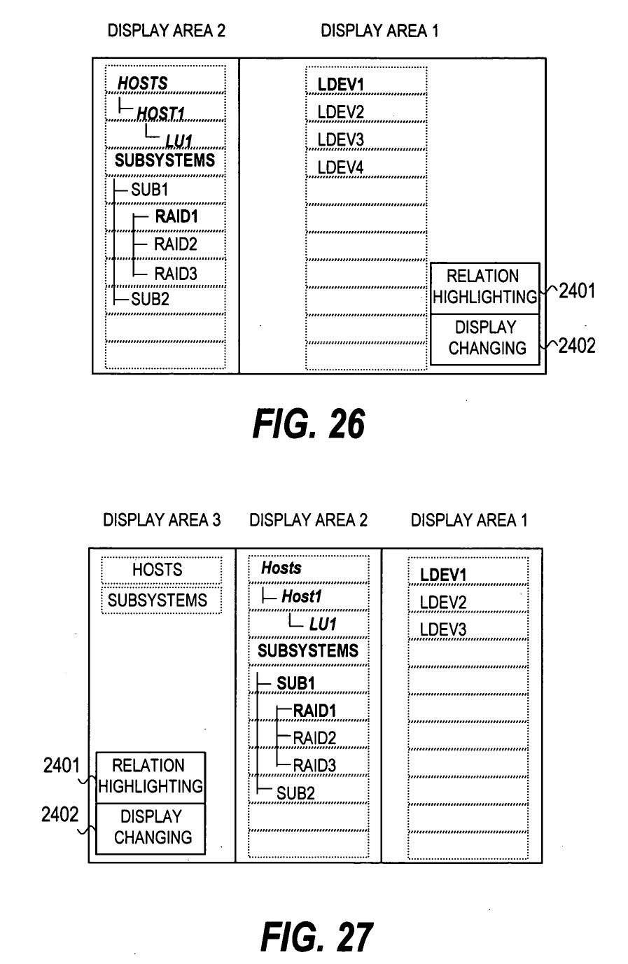

In the display area 1, a relation highlighting button 2401 and a display changing button 2402 are displayed. Those buttons will be described below (see FIGS. 26 and 27). The buttons are displayed in optional blank spaces of the screen, so these buttons may be displayed in any display areas.

FIG. 25 is an explanatory diagram of an example of a screen displayed with selection highlighting in the output device 202 according to the embodiment of this invention.

In FIG. 24, when the system administrator instructs “Subsystems” by the pointing device, SUB 1 and SUB 2 that are child objects of the root object Subsystems are displayed in the display area 2. The instruction by the pointing device may be executed by placing a cursor on the “Subsystems” and clicking it by the mouse, or by other ways. In the description below, “instruct” means such an instruction by the pointing device.

When the system administrator instructs “SUB 1”, RAID's 1 to 3 that are child objects of the SUB 1 are displayed in the display area 2. Further, when the system administrator instructs “RAID 1”, LDEV's 1 to 3 that are child objects of the RAID 1 are displayed in the display area 1 shown in FIG. 25.

In this case, as the child objects of the Subsystems, the SUB 1, and the RAID 1 are displayed, these objects are displayed with selection highlighting. In an example of FIG. 25, these objects are displayed by bold faces.

Contents of the object management table 209, the display control table 210, and the display memory 211 when the screen of FIG. 25 is displayed are as shown in FIGS. 11 to 14.

FIG. 26 is an explanatory diagram of an example of a screen displayed with relation highlighting in the output device 202 according to the embodiment of this invention.

In FIG. 25, when the system administrator instructs the LDEV 1 and the relation highlighting button 2401, all upper objects related to the LDEV 1 are displayed with relation highlighting as shown in FIG. 26. A procedure of the relation highlighting is as shown in the steps 1604 and 1605 of FIG. 16, and FIG. 17 or the like.

As described above, the RAID 1 is a parent object of the LDEV 1, the SUB 1 is a parent object of the RAID 1, and the Subsystems is a parent object of the SUB 1. In other words, these objects are upper objects related to the LDEV 1. Further, as shown in FIG. 12, the LU 1 is a parent object of the LDEV 1, the Host 1 is a parent object of the LU 1, and the Hosts is a parent object of the Host 1. In other words, the Hosts, the Host 1, and the LU 1 are upper objects related to the LDEV 1. Thus, these upper objects are displayed with relation highlighting. However, objects that have been displayed with selection highlighting are not displayed with relation highlighting (see steps 1703 and 1707 of FIG. 17).

As a result, as shown in FIG. 26, the Hosts, the Host 1, and the LU 1 are displayed with relation highlighting. In an example of FIG. 26, these objects are indicated by italics. Thus, these objects are displayed in a form different from the objects displayed with selection highlighting. However, for example, the objects displayed with relation highlighting may be displayed by colors or graphics different from those of the objects displayed with selection highlighting.

In FIG. 25, the Host 1 and the LU 1 below the Hosts are not shown. Accordingly, to display those objects with relation highlighting, they are displayed below “Hosts” of the display area 2. Further, the display positions of the Subsystems and the objects below are changed lower by two in the step 1709 of FIG. 17.

FIG. 27 is an explanatory diagram of an example of a screen which includes a display area 3 displayed in the output device 202 according to the embodiment of this invention.

When the system administrator instructs the display changing button 2402, the display area 3 is displayed in the left side of the display area 2. Alternatively, when all the present root objects cannot be displayed any more in the display area 2, the display area 3 may be automatically displayed in the step 1715 of FIG. 17.

For example, as a result of displaying many objects below the “Hosts” in the display area 2, “Subsystems” may not be displayed in the display area 2. In this case, the system administrator can display the “Subsystems” by scrolling the display area 2. As a result, however, the “Hosts” may be moved away to the outside of the display area 2 not to be displayed any more. When the system administrator further executes scrolling to move away even the “subsystems” to the outside of the display area 2, displaying of the “Subsystems” is added in the display area 3.

Alternatively, when the display area 3 is first displayed, all the root objects may be automatically displayed in the display area 3.

The example of FIG. 27 shows the screen where the “Hosts” and the “Subsystems” are displayed in the display area 3.

FIG. 28 is an explanatory diagram of an example of a screen divided and displayed in the output device 202 according to the embodiment of this invention.

FIG. 28 shows the screen where a display area 2 is vertically divided by a boundary line and objects are displayed in the divided areas. In the divided upper and lower areas, objects belonging to the same tier and lower objects are displayed.

In the example of FIG. 28, Hosts as a root object and lower objects (Host 1 and the like) are displayed in the divided upper area. In the lower area, Subsystems as a root object and lower objects (SUB 1 and the like) are displayed. In other words, the upper area corresponds to the object management table 209 regarding the host shown in FIG. 12, and the lower area corresponds to the object management table 209 regarding the subsystems shown in FIG. 11.

FIG. 29 is an explanatory diagram of an example of a screen where a boundary line displayed in the output device 202 is moved according to the embodiment of this invention.

When the display area is divided, the system administrator can change a position of the boundary line by instructing a dividing boundary line in the step 1606 of FIG. 16 and FIG. 18. FIG. 29 shows the screen where the system administrator moves up the boundary line of FIG. 28 by one. As a result, “SUB 2” not displayed in FIG. 28 is displayed in FIG. 29.

In FIGS. 28 and 29, the display area 2 is scrolled for each divided area. In this case, each area may be scrolled for each root object. Alternatively, the display positions of the root objects (“Hosts” and “Subsystems”) of each area may be fixed, and the lower objects alone may be scrolled.

According to the embodiment of this invention, the system diagram of the objects is displayed on the screen. When the system administrator instructs a certain object on the screen and relation highlighting, all the upper objects related to the instructed object are highlighted. As a result, even when one object has a plurality of parent objects, the system administrator can specify all the related upper objects.

What is claimed is:

1. A method of managing a computer system comprising a host computer and a storage subsystem,
the host computer and the storage subsystem being coupled to a management computer through a first network,
the host computer and the storage subsystem being coupled to each other through a second network,
the management computer comprising a first interface for communicating through the first network, a first processor coupled to the first interface, a first memory coupled to the first processor, an input device for receiving an input, and an output device for displaying information,
the host computer comprising a second interface coupled to the first network, a third interface coupled to the second network, a second processor coupled to the second interface and the third interface, and a second memory coupled to the second processor,
the storage subsystem comprising a disk drive for storing data used by the host computer, and a controller for controlling the disk drive,
the method comprising:
displaying objects included in the computer system and related to one another in a display area of the output device; and
displaying, when the input device receives an input of designating one of the objects, an object related to be higher than the designated object in a form different from a form of the other objects in the display area of the output device.

2. The method according to claim 1, wherein:
the storage subsystem comprises a parity group constituted of two or more disk drives;
the parity group includes a logical device;
the storage subsystem is provided with a logical unit assigned to the logical device;
the objects include at least the host computer, the storage subsystem, the parity group, the logical unit, and the logical device;
the storage subsystem is related to be higher than the parity group of the storage subsystem;.
the parity group is related to be higher than the logical device included therein;
the host computer is related to be higher than the logical unit accessed by the host computer; and
the logical unit is related to be higher than the logical device assigned to the logical unit.

3. The method according to claim 1, further comprising displaying the objects sequentially on the output device when objects to be displayed in the different form on the output device are not simultaneously displayed on the output device.

4. The method according to claim 1, further comprising, when an uppermost object is no longer displayed in an original display area as a result of scrolling the display area,
setting a new display area in the output device, and
displaying the object displayed no longer in the original display area, in the new display area.

5. The method according to claim 1, the output device being provided with a plurality of display areas; the first memory stores display control information for defining tiers of the objects to be displayed in the display areas,
the method further comprising displaying the objects of the respective tiers in the display areas based on the display control information.

6. The method according to claim 5, further comprising:
dividing one of the display areas into a plurality of areas;
displaying a first object and the objects lower than the first object in one of the divided areas; and
displaying a second object of the same tier as a tier of the first object and the objects lower than the second object in another of the divided areas.

7. The method according to claim 1, wherein the form comprises a color.

8. A management computer for managing a computer system comprising a host computer and a storage subsystem,
the management computer being coupled to the host computer and the storage subsystem through a first network,
the host computer and the storage subsystem being coupled to each other through a second network,
the management computer comprising:
a first interface for communicating through the first network;
a first processor coupled to the first interface;
a first memory coupled to the first processor;
an input device for receiving an input; and
an output device for displaying information,
the host computer comprising a second interface coupled to the first network, a third interface coupled to the second network, a second processor coupled to the second interface and the third interface, and a second memory coupled to the second processor,
the storage subsystem comprising a disk drive to store data used by the host computer, and a controller for controlling the disk drive,
wherein:
the first processor displays objects included in the computer system and related to one another in a display area of the output device; and
when the input device receives an input of designating one of the objects, the first processor displays an object related to be higher than the designated object in a form different from a form of the other objects in the display area of the output device.

9. The management computer according to claim 8, wherein:
the storage subsystem comprises a parity group constituted of two or more disk drives;
the parity group includes a logical device;
the storage subsystem is provided with a logical unit assigned to the logical device;
the objects include at least the host computer, the storage subsystem, the parity group, the logical unit, and the logical device;
the storage subsystem is related to be higher than the parity group of the storage subsystem;
the parity group is related to be higher than the logical device included therein;
the host computer is related to be higher than the logical unit accessed by the host computer; and
the logical unit is related to be higher than the logical device assigned to the logical unit.

10. The management computer according to claim 8, wherein when objects to be displayed in the different form on the output device are not simultaneously displayed on the output device, the first processor displays the objects sequentially on the output device.

11. The management computer according to claim 8, wherein when an uppermost object is no longer displayed in an original display area as a result of scrolling the display area, the first processor sets a new display area in the output device, and displays the object displayed no longer in the original display area, in the new display area.

12. The management computer according to claim 8, the output device being provided with a plurality of display areas; the first memory stores display control information for defining tiers of the objects to be displayed in the display areas,
wherein the first processor displays the objects of the respective tiers in the display areas based on the display control information.

13. The management computer according to claim 12, wherein:
one of the display areas is further divided into a plurality of areas; and
the first processor displays a first object and the objects lower than the first object in one of the divided areas, and displays a second object of the same tier as that of the first object and the objects lower than the second object in another of the divided areas.

14. The management computer according to claim 8, wherein the form comprises a color.
